(19) United States
(12) Patent Application Publication
(10) Pub. No.: US 2012/0314093 A1
(43) Pub. Date: Dec. 13, 2012

(54) IMAGE PROCESSING APPARATUS AND METHOD, PROGRAM, AND RECORDING MEDIUM

(75) Inventors: Ken TAMAYAMA, Tokyo (JP); Takefumi Nagumo, Kanagawa (JP); Tamaki Eyama, Tokyo (JP); Masaki Handa, Kanagawa (JP); Yuhi Kondo, Tokyo (JP)

(73) Assignee: SONY CORPORATION, Tokyo (JP)

(21) Appl. No.: 13/480,687

(22) Filed: May 25, 2012

(30) Foreign Application Priority Data
Jun. 10, 2011 (JP) 2011-130652

(51) Int. Cl. H04N 5/225

(52) U.S. Cl. 348/208.1; 348/208.6; 348/E05.024

(57) ABSTRACT

Provided is an image processing apparatus for correcting a motion blur or an out-of-focus blur of images continuous in time, including an extraction unit for extracting a frequency component not included in an image of interest using a predetermined filter from a corrected image in which the motion blur or the out-of-focus blur is corrected as an image temporally previous to the image of interest aligned with the image of interest, and a synthesis unit for synthesizing the frequency component extracted by the extraction unit with the image of interest.

### BACKGROUND

The present technology relates to an image processing apparatus and method, a program, and a recording medium, and more particularly to an image processing apparatus and method, a program, and a recording medium, which can enable a motion blur or an out-of-focus blur to be corrected while suppressing an artifact such as ringing or a ghost.

According to movement of a camera or an object during exposure, a motion blur or an out-of-focus blur occurring in a captured image is modeled by convoluting a two-dimensional impulse response (point spread function (PSF)) determined from an optical axis or a trajectory of the object with an original image. Recently, technology of deconvolution as means for reversing the convolution, that is, correcting the motion blur or the out-of-focus blur, has been studied.

Although the motion blur or the out-of-focus blur can be corrected to a certain extent according to a technique using a Wiener filter, which is one of traditional deconvolution methods, an image before the occurrence of the motion blur or the out-of-focus blur may not be restored even when the PSF is accurately known, and an artifact referred to as ringing or a ghost is caused. Information according to a zero point (cutoff frequency component) seen periodically or in many of high frequencies in a frequency response corresponding to the convoluted PSF is missed, so that the ringing or ghost occurs. This is also the same in other methods as long as a deconvolution method is linear.

A technique of preventing a zero point from being generated as a whole by obtaining one motion-blur-corrected image from a plurality of motion-blurred images and preventing the zero point from overlapping for every plurality of motion-blurred images has been proposed (for example, see Agrawal et al., “Invertible motion blur in video,” SIGGRAPH, ACM Transactions on Graphics, August 2009).

### SUMMARY

However, because a frame memory for motion-blurred images necessary to obtain one motion-blur-corrected image is necessary in the above-described technique, a circuit scale may be increased if the frame memory is implemented by hardware.

In addition, because this is an algorithm for obtaining one image from a plurality of images, a calculation amount may be increased when a real-time moving image is processed.

It is desirable to correct a motion blur or an out-of-focus blur with a smaller circuit scale and a smaller calculation amount while suppressing an artifact such as ringing or a ghost.

According to a first embodiment of the present technology, there is provided an image processing apparatus for correcting a motion blur or an out-of-focus blur of images continuous in time, including: an extraction unit for extracting a frequency component not included in an image of interest using a predetermined filter from a corrected image in which the motion blur or the out-of-focus blur is corrected as an image temporally previous to the image of interest aligned with the image of interest; and a synthesis unit for synthesizing the frequency component extracted by the extraction unit with the image of interest.

The image processing apparatus may further include: a correction unit for correcting the motion blur or the out-of-focus blur of the image of interest using a complementary filter, which has substantially inverse characteristics to frequency characteristics of the motion blur or the out-of-focus blur and is complementary to the filter, wherein the synthesis unit synthesizes the image of interest the motion blur or the out-of-focus blur of which is corrected by the correction unit with the frequency component.

The image processing apparatus may further include: an addition unit for adding the image of interest, which is synthesized with the frequency component by the synthesis unit, to the corrected image according to a predetermined addition weight.

In the image processing apparatus, resolution of the corrected image may be second resolution, which is higher than first resolution as resolution of the image of interest, and the filter and the complementary filter may set the resolution of the image of interest from the first resolution to the second resolution.

The image processing apparatus may further include: an addition unit for adding the image of interest of the second resolution and the corrected image according to a predetermined addition weight.

The image processing apparatus may further include: a detection unit for detecting variation in alignment with the image of interest and the corrected image; and an output unit for outputting an image obtained by adjusting a rate of synthesis of the image of interest, which is synthesized with the frequency component by the synthesis unit, with the image of interest, which is not subjected to any process, according to the variation detected by the detection unit.

The image processing apparatus may further include: an estimation unit for estimating a direction and a length of the motion blur or the out-of-focus blur of the image of interest on the basis of variation of a position between the image of interest and the corrected image, wherein the correction unit corrects the motion blur or the out-of-focus blur of the image of interest using the complementary filter corresponding to the direction and the length of the motion blur or the out-of-focus blur of the image of interest estimated by the estimation unit.

The correction unit may correct the motion blur or the out-of-focus blur of an object in the image of interest by removing a background part other than the object, which is a moving body in the image of interest, on the basis of the corrected image, the image of interest, and an image temporally subsequent to the image of interest.

The frequency component not included in the image of interest may be a frequency component in the vicinity of a zero point of frequency characteristics in which the motion blur or the out-of-focus blur of the image of interest is modeled.

According to a second embodiment of the present technology, there is provided an image processing method for use in an image processing apparatus for correcting a motion blur or an out-of-focus blur of images continuous in time, wherein the image processing apparatus includes an extraction unit for extracting a frequency component not included in an image of interest using a predetermined filter from a corrected image in which the motion blur or the out-of-focus blur is corrected as an image temporally previous to the image of interest aligned with the image of interest, and a synthesis unit for synthesizing the frequency component extracted by the extraction unit with the image of interest, the image processing method including: extracting, by way of the image processing apparatus, the frequency component not included in the image of interest using the predetermined filter from the corrected image in which the motion blur or the out-of-focus blur is corrected as the image temporally previous to the image of interest aligned with the image of interest; and synthesizing, by way of the image processing apparatus, the extracted frequency component with the image of interest.

According to third embodiments of the present technology, there are provided a program and a recording medium for causing a computer to execute a process of correcting a motion blur or an out-of-focus blur of images continuous in time, including extracting a frequency component not included in an image of interest using a predetermined filter from a corrected image in which the motion blur or the out-of-focus blur is corrected as an image temporally previous to the image of interest aligned with the image of interest; and synthesizing the frequency component extracted by a process of the extracting step with the image of interest.

According to a fourth embodiment of the present technology, a frequency component not included in an image of interest using a predetermined filter is extracted from a corrected image in which a motion blur or an out-of-focus blur is corrected as an image temporally previous to the image of interest aligned with the image of interest, and the extracted frequency component is synthesized with the image of interest.

According to the embodiments of the present technology described above, it is possible to correct a motion blur or an out-of-focus blur with a smaller circuit scale and a smaller calculation amount while suppressing an artifact such as ringing or a ghost.

### BRIEF DESCRIPTION OF THE DRAWINGS

FIG. 1 is a block diagram illustrating a functional configuration example of an embodiment of an image processing apparatus to which the present technology is applied;

FIG. 2 is a diagram illustrating frequency responses of a Wiener filter and a null filling filter corresponding to a parameter ρ;

FIG. 3 is a flowchart illustrating a motion-blur correction process;

FIG. 4 is a block diagram illustrating a modified example of an image processing apparatus of FIG. 1;

FIG. 5 is a flowchart illustrating a motion-blur correction process of the image processing apparatus of FIG. 4;

FIG. 6 is a block diagram illustrating the principle of another modified example of the image processing apparatus of FIG. 1;

FIG. 7 is a block diagram illustrating another modified example of the image processing apparatus of FIG. 1;

FIG. 8 is a block diagram illustrating a functional configuration example of an image processing apparatus of the related art that performs a noise reduction process;

FIG. 9 is a block diagram illustrating another functional configuration example of the image processing apparatus to which the present technology is applied;

FIG. 10 is a diagram illustrating a replacement of a processing unit related to noise reduction;

FIG. 11 is a diagram illustrating a configuration in which a function of the present technology is added to a processing unit related to noise reduction;

FIG. 12 is a flowchart illustrating a motion-blur correction process of the image processing apparatus of FIG. 9;

FIG. 13 is a block diagram illustrating a functional configuration example of the image processing apparatus of the related art that performs a super-resolution process;

FIG. 14 is a block diagram illustrating still another functional configuration example of the image processing apparatus to which the present technology is applied;

FIG. 15 is a block diagram illustrating still another functional configuration example of the image processing apparatus to which the present technology is applied;

FIG. 16 is a diagram illustrating a configuration in which a super-resolution function is added to a block related to noise reduction;

FIG. 17 is a diagram illustrating uniformly accelerated motion of an object;

FIG. 18 is a diagram illustrating a motion blur of the object that performs uniformly accelerated motion;

FIG. 19 is a block diagram illustrating still another functional configuration example of an image processing apparatus to which the present technology is applied;

FIG. 20 is a block diagram illustrating a functional configuration example of a motion-blur correction unit of FIG. 19;

FIG. 21 is a flowchart illustrating a motion-blur correction process of the image processing apparatus of FIG. 19;

FIG. 22 is a flowchart illustrating a background removal/motion-blur correction process; and

FIG. 23 is a block diagram illustrating a configuration example of hardware of a computer.

### DETAILED DESCRIPTION OF THE EMBODIMENT(S)

Hereinafter, preferred embodiments of the present disclosure will be described in detail with reference to the appended drawings. Description will be given in the following order.

1. Configuration of Image Processing Apparatus

2. Motion-Blur Correction Process

3. Addition of Noise Reduction Function

4. Addition of Super-Resolution Processing Function

5. Example of Estimation Method of PSF

6. Configuration of Image Processing Apparatus that Performs Motion-Blur Correction Only for Motion-Blurred Object

### 1. Configuration of Image Processing Apparatus

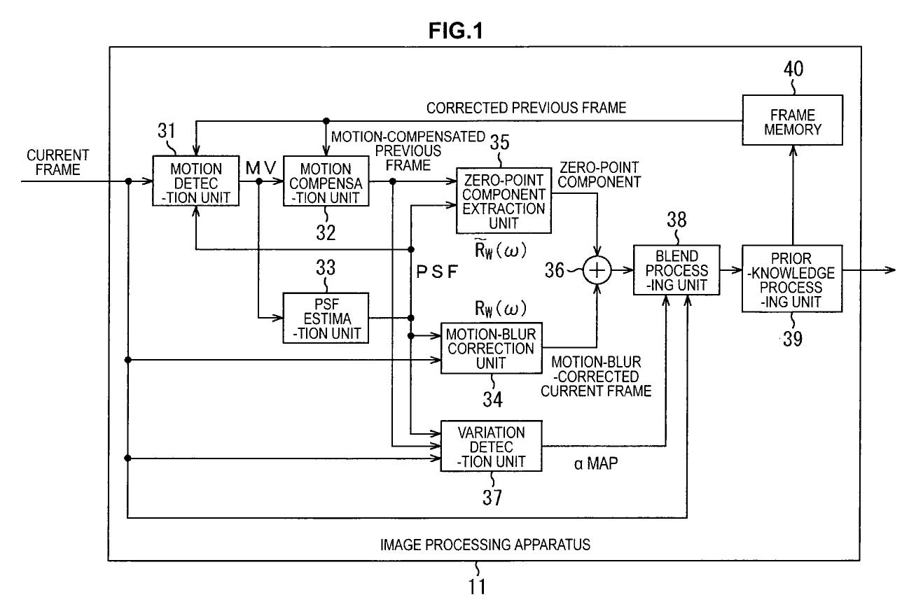

FIG. 1 illustrates a configuration of an embodiment of the image processing apparatus to which the present technology is applied.

The image processing apparatus 11 of FIG. 1 performs a motion-blur correction process of correcting a motion blur for images, which are continuous in time, for example, received from an imaging apparatus (not illustrated), and provides a motion-blur correction result to a storage apparatus or a display apparatus (not illustrated). Although the images input to the image processing apparatus 11 may be continuously captured still images or moving images, the images will be described hereinafter as moving images formed of a plurality of frames. In addition, the image processing apparatus 11 may be provided in an imaging apparatus such as a digital camera.

The image processing apparatus 11 of FIG. 1 includes a motion detection unit 31, a motion compensation unit 32, a PSF estimation unit 33, a motion-blur correction unit 34, a zero-point component extraction unit 35, a synthesis unit 36, a variation detection unit 37, a blend processing unit 38, a prior-knowledge processing unit 39, and a frame memory 40.

The motion detection unit 31 performs motion estimation (ME) (motion detection) for a current frame, which is an image of interest (a frame of interest) currently input, and a frame (hereinafter referred to as a previous frame), which is one frame earlier than the current frame, retained in the frame memory 40 among the continuously input images, and obtains a motion vector (MV) indicating the variation of a position of the current frame to the previous frame. At this time, the motion detection unit 31 obtains the motion vector by processing an out-of-focus blur for the previous frame on the basis of a PSF provided from the PSF estimation unit 33. The motion detection unit 31 provides the obtained motion vector to the motion compensation unit 32 and the PSF estimation unit 33.

The motion compensation unit 32 performs motion compensation (MC) for the previous frame retained in the frame memory on the basis of the motion vector from the motion detection unit 31, and obtains a motion-compensated previous frame aligned with the current frame. The motion compensation unit 32 provides the obtained motion-compensated previous frame to the zero-point component extraction unit 35 and the variation detection unit 37.

The PSF estimation unit 33 obtains the PSF by performing PSF estimation for modeling a motion blur included in the current frame on the basis of the motion vector from the motion detection unit 31. Specifically, for example, the PSF estimation unit 33 obtains the PSF by obtaining a direction and length of the motion blur from (motion vector (MV))×(Exposure Time)÷(Frame Cycle). The PSF estimation unit 33 provides the obtained PSF to the motion detection unit 31, the motion-blur correction unit 34, the zero-point component extraction unit 35, and the variation detection unit 37.

The motion-blur correction unit 34 configures a Wiener filter on the basis of the PSF from the PSF estimation unit 33, obtains a motion-blur-corrected current frame by applying the Wiener filter to the current frame, and provides the obtained motion-blur-corrected current frame to the synthesis unit 36.

The zero-point component extraction unit 35 configures a null filling filter on the basis of the PSF from the PSF estimation unit 33, extracts a zero-point component (a frequency component including a zero point in the vicinity of the zero point), which is a frequency component not included in frequency characteristics of the motion blur (PSF) of the current frame, from the motion-compensated previous frame by applying the null filling filter to the motion-compensated previous frame from the motion compensation unit 32, and provides the extracted zero-point component to the synthesis unit 36.

[Transfer Functions of Wiener Filter and Null Filling Filter]

Here, the transfer functions of the Wiener filter and the null filling filter will be described. The transfer function R_{W}(ω) of the Wiener filter and the transfer function \tilde{R}_{W}(ω) of the null filling filter are expressed by the following Expressions (1).

$$\begin{matrix}{R}_{W} ( ω ) \frac{\overline{H} ( ω )}{{\vert H ( ω ) \vert}^{2} + ρ} & ( 1 ) \\ {\tilde{R}}_{W} ( ω ) = \frac{ρ}{{\vert H ( ω ) \vert}^{2} + ρ} & \end{matrix}$$

In Expressions (1), H(ω) is a motion-blur model (hereinafter also referred to as an out-of-focus blur model) expressed by the PSF, and a signal to noise (S/N) ratio is assumed to be fixed. As shown in Expressions (1), the transfer function R_{W}(ω) of the Wiener filter and the transfer function \tilde{R}_{W}(ω) of the null filling filter have a common parameter ρ. The higher the S/N ratio, the smaller the parameter ρ. The Wiener filter is close to an inverse filter having ideal inverse characteristics with respect to the motion blur. In addition, the lower the S/N ratio, the larger the parameter ρ. The Wiener filter is far from the ideal inverse filter and has characteristics as in a low pass filter. Specifically, the parameter ρ indicates the strength of motion-blur correction by the Wiener filter at a noise level when white noise is assumed. When the strength of motion-blur correction by the Wiener filter is weak, the number of components passing through the corresponding null filling filter increases. That is, a weight is adjusted between the motion-blur correction for the current frame and the correction result of the motion-compensated previous frame according to the parameter ρ.

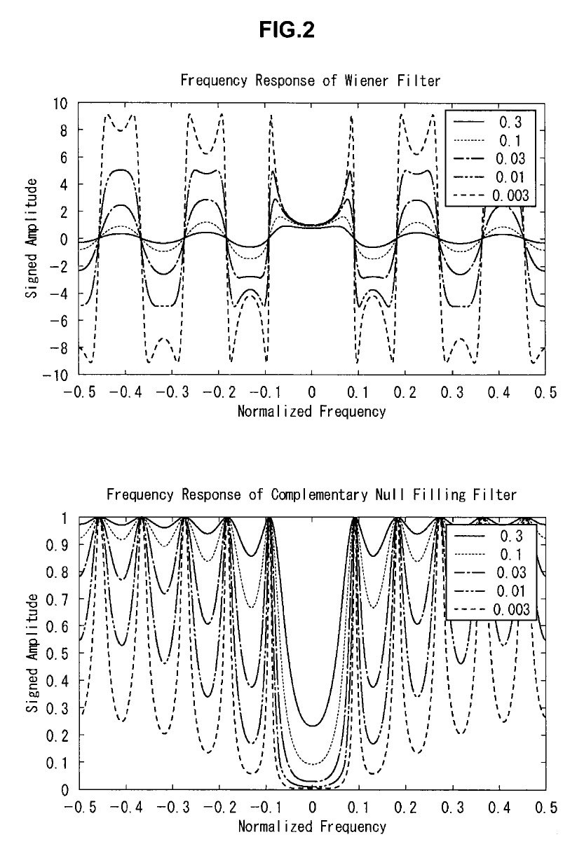

FIG. 2 illustrates examples of frequency responses of the Wiener filter and the null filling filter. In FIG. 2, at the upper side, the examples of the frequency responses of the Wiener filter are illustrated when the parameter ρ is 0.3, 0.1, 0.03, 0.01, and 0.003. At the lower side, the examples of the frequency responses of the null filling filter are illustrated when the parameter ρ is 0.3, 0.1, 0.03, 0.01, and 0.003. As illustrated in FIG. 2, an amplitude in the frequency response of the null filling filter has a maximum value 1 at a point (frequency) at which an amplitude in the frequency response of the Wiener filter is 0. As described above, this indicates that the number of components passing through the corresponding null filling filter increases if the strength of the motion-blur correction by the Wiener filter is weak. The Wiener filter and the null filling filter have a complementary relationship. Here, the complementary relationship refers to a relationship between the Wiener filter and the null filling filter when a sum of the frequency characteristic of a result of out-of-focus blur correction by the Wiener filter for an out-of-focus blur model (out-of-focus blur) and the frequency characteristic of the null filling filter becomes 1.

Here, although the Wiener filter and the null filling filter having the complementary relationship with the Wiener filter have been described, it is possible to apply filters R and \tilde{R} satisfying the complementation (complementary relationship) as shown in the following Expressions (2) to the present technology when an image is F and an out-of-focus blur model is H.

R·H·F+\tilde{R}·F=F

\tilde{R}=1−R·H (2)

Returning to the description of FIG. 1, the synthesis unit 36 synthesizes (adds) the motion-blur-corrected current frame from the motion-blur correction unit 34 with the zero-point component of the motion-compensated previous frame from the zero-point component extraction unit 35, and provides the zero-point-component-synthesized (compensated) current frame to the blend processing unit 38.

The variation detection unit 37 compares the current frame to the motion-compensated previous frame, and detects the variation of a position between the frames. At this time, the variation detection unit 37 compares the current frame to the motion-compensated previous frame by processing an out-of-focus blur for the motion-compensated previous frame on the basis of the PSF from the PSF estimation unit 33. According to the variation between the current frame and the motion-compensated previous frame, the variation detection unit 37 generates an α map by allocating a value (hereinafter referred to as a value α) closer to 1 to an area at which the variation is larger and allocating a value closer to 0 to an area at which the variation is smaller, and provides the α map to the blend processing unit 38. The value α becomes 0 to 1 in the α map.

The blend processing unit 38 performs a blend process of outputting a frame, which is obtained by adjusting a rate of synthesis of a zero-point-component-compensated current frame from the synthesis unit 36 with the original current frame not subjected to any process, as a current frame for each area on the basis of the α map from the variation detection unit 37. The blend processing unit 38 provides the current frame obtained from the result of the blend process to the prior-knowledge processing unit 39.

The prior-knowledge processing unit 39 performs a process using predetermined prior knowledge for the current frame from the blend processing unit 38, outputs a result of the process to the storage apparatus or the display apparatus (not illustrated), and causes the frame memory 40 to retain (store) the result.

The frame memory 40 delays the current frame from the prior-knowledge processing unit 39 by the time of one frame, and provides the motion detection unit 31 and the motion compensation unit 32 with the delayed current frame as a previous frame (hereinafter referred to as a corrected previous frame) for which a motion-blur correction process is completed.

### 2. Motion-Blur Correction Process

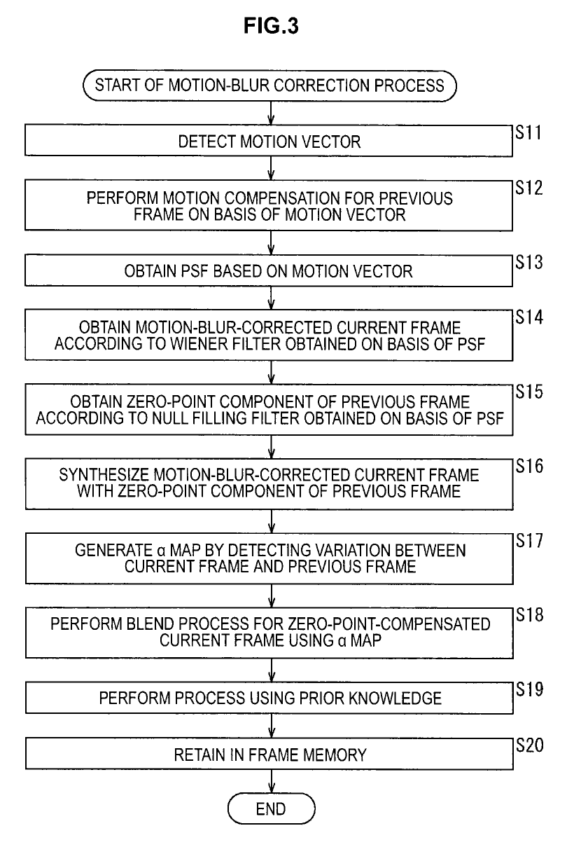

Next, the motion-blur correction process by the image processing apparatus 11 will be described with reference to the flowchart of FIG. 3.

In step S11, the motion detection unit 31 detects a motion vector on the basis of a current frame among continuously input images and a corrected previous frame (hereinafter simply referred to as a previous frame) retained in the frame memory 40. At this time, the motion detection unit 31 detects the motion vector by processing an out-of-focus blur for the previous frame on the basis of a PSF from the PSF estimation unit 33. Thereby, it is possible to include a degree of a motion blur of the previous frame, which does not include a large motion blur, in a current frame including the motion blur and improve the accuracy of motion vector detection. The motion detection unit 31 provides the detected motion vector to the motion compensation unit 32 and the PSF estimation unit 33.

In step S12, the motion compensation unit 32 performs motion compensation for the previous frame retained in the frame memory 40 on the basis of the motion vector from the motion detection unit 31, and obtains the motion-compensated previous frame. The motion compensation unit 32 provides the obtained motion-compensated previous frame to the zero-point component extraction unit 35 and the variation detection unit 37.

In step S13, the PSF estimation unit 33 obtains a PSF based on the motion vector from the motion detection unit 31, and provides the obtained PSF to the motion detection unit 31, the motion-blur correction unit 34, the zero-point component extraction unit 35, and the variation detection unit 37.

In step S14, the motion-blur correction unit 34 obtains the motion-blur-corrected current frame according to the Wiener filter obtained on the basis of the PSF from the PSF estimation unit 34, and provides the motion-blur-corrected current frame to the synthesis unit 36. The motion-blur-corrected current frame obtained as described above includes ringing or a ghost due to the influence of a zero point seen in the motion-blur frequency characteristics and the frequency characteristics of the Wiener filter. In addition, in the motion-blur-corrected current frame, noise included in the original current frame is amplified according to the frequency characteristics of the Wiener filter.

In step S15, the zero-point component extraction unit 35 extracts a zero-point component of the motion-compensated previous frame according to the null filling filter obtained on the basis of the PSF from the PSF estimation unit 33, and provides the extracted zero-point component to the synthesis unit 36. The zero-point component of the motion-compensated previous frame obtained as described above becomes a signal component for eliminating a ringing component remaining in the motion-blur-corrected current frame if the motion blur is sufficiently corrected in the corrected previous frame from the frame memory 40.

In step S16, the synthesis unit 36 synthesizes the motion-blur-corrected current frame from the motion-blur correction unit 34 with the zero-point component of the motion-compensated previous frame from the zero-point component extraction unit 35, and provides a synthesis result to the blend processing unit 38. Thereby, the current frame for which the motion blur is corrected and the compensation is performed for the zero point serving as the cause of ringing is obtained. Here, the zero-point component incapable of being restored due to loss of information in the motion-blur-corrected current frame from the motion-blur correction unit 34 is expected to be included in a previous frame as a result in which frames are corrected one by one, so that the problem of ringing is solved.

In step S17, the variation detection unit 37 generates an α map by detecting the variation of a position between the current frame and the motion-compensated previous frame, and provides the generated α map to the blend processing unit 38.

In the α map, a value α closer to 1 is allocated to an area (pixel) at which the variation between the current frame and the motion-compensated previous frame is larger, and a value α closer to 0 is allocated to an area (pixel) at which the variation is smaller. That is, in the α map, the value α closer to 0 is allocated to an area at which motion detection (ME) or motion compensation (MC) is considered to have failed.

In step S18, the blend processing unit 38 performs a blend process for each area with respect to the zero-point-component-compensated current frame from the synthesis unit 36 and the original current frame using the α map from the variation detection unit 37. Specifically, an image for each area obtained by the blend process is given according to the following Expression (3).

α{R(ω)·Cur+\tilde{R}(ω)·MC}(1−α)·Cur (3)

In Expression (3), Cur denotes the current frame and MC denotes the motion-compensated previous frame. That is, in the α map, the value α becomes a value close to 1 and the zero-point-component-compensated current frame is output from the synthesis unit 36 at a high ratio, in an area at which the ME or MC result is reliable. In an area at which the ME or MC is considered to have failed, the value α becomes a value close to 0 and the original current frame is output at a high ratio. Thereby, it is possible to prevent a defective image from being output due to an iterative process in a state in which the ME or MC has failed.

In step S19, the prior-knowledge processing unit 39 performs a process using predetermined prior knowledge for the current frame obtained by the blend process. Specifically, the prior-knowledge processing unit 39 performs a process of smoothing an edge while retaining the edge using minimization of total variation or sparsity of the gradient of a pixel value as technology used for noise suppression. Thereby, the corrected current frame is finally obtained.

In step S20, the prior-knowledge processing unit 39 causes the frame memory 40 to retain the finally corrected current frame. The current frame retained in the frame memory 40 is delayed by the time of one frame and provided to the motion detection unit 31 and the motion compensation unit 32 as a corrected previous frame in a motion-blur correction process for the next frame. That is, the motion-blur correction process of FIG. 3 is executed for every one frame.

According to the above-described process, an artifact such as ringing or a ghost can be suppressed because a zero-point component not included in the current frame is extracted from the corrected previous frame and the zero-point component is synthesized with the corrected current frame. Although correction of a plurality of frames is reflected in the corrected previous frame, it is preferable that the frame memory for one frame be provided because frames are processed one by one. In addition, because the above-described process is a sequential process for continuous frames, a calculation amount is also reduced for real-time moving images. Therefore, it is possible to correct the motion blur with a smaller circuit scale and a smaller calculation amount while suppressing an artifact such as ringing or a ghost.

In addition, because position variation between the current frame and the previous frame is detected, the defect of an image due to the failure of ME or MC can be prevented.

In particular, even when an artifact such as ringing or a ghost occurs in a boundary part of a moving object with a background when ME or MC has failed in the motion-blur correction by a technique of deconvolution, it is possible to suppress the artifact such as the ringing or ghost by detecting the position variation between the current frame and the previous frame.

Although the blend process performed for the zero-point-component-compensated current frame from the synthesis unit 36 and the original current frame has been described above, the blend process may be performed, for example, for the motion-compensated previous frame and the original current frame.

### Modified Example of Image Processing Apparatus

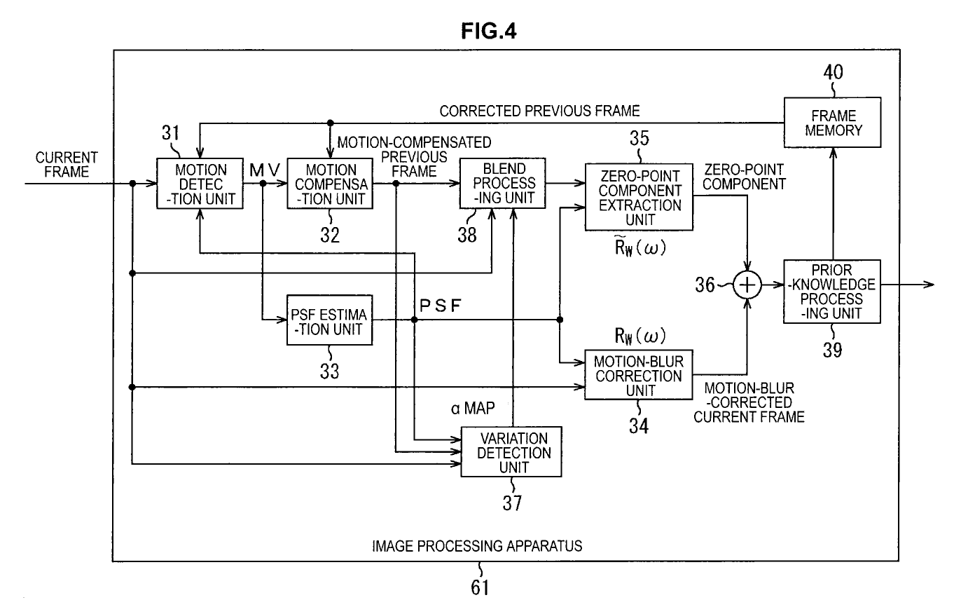

Here, the image processing apparatus in which a blend process is performed for a motion-compensated previous frame and an original current frame will be described with reference to FIG. 4.

In the image processing apparatus 61 of FIG. 4, elements having the same functions as provided in the image processing apparatus 11 of FIG. 1 are denoted by the same names and the same reference numerals and description thereof is appropriately omitted.

That is, the image processing apparatus 61 of FIG. 4 is different from the image processing apparatus 11 of FIG. 1 in that the blend processing unit 38 provided between the synthesis unit 36 and the prior-knowledge processing unit 39 is provided between the motion compensation unit 32 and the zero-point component extraction unit 35.

### Another Example of Motion-Blur Correction Process

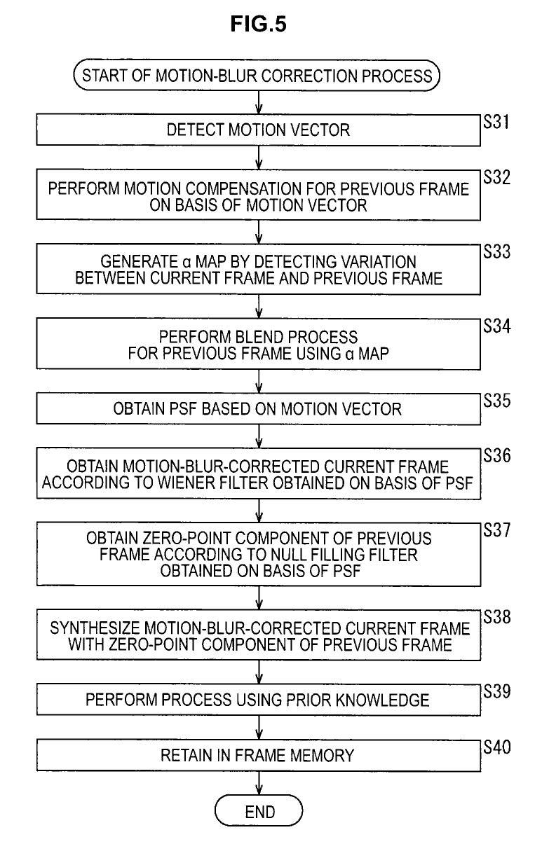

Next, the motion-blur correction process of the image processing apparatus 61 of FIG. 4 will be described with reference to the flowchart of FIG. 5.

Because the process of steps S31, S32, and S35 to S40 of the flowchart of FIG. 5 is the same as the process of steps S11 to S16, S19, and S20 of the flowchart of FIG. 3, description thereof is omitted.

In step S33, the variation detection unit 37 generates an α map by detecting the variation of a position between the current frame and the motion-compensated previous frame, and provides the generated α map to the blend processing unit 38.

In step S34, the blend processing unit 38 performs a blend process for each area with respect to the motion-compensated previous frame and the current frame using the α map from the variation detection unit 37. An image (frame) obtained by the blend process is provided to the zero-point-component extraction unit 35 as the motion-compensated previous frame.

The motion-blur correction process illustrated in the flowchart of FIG. 5 can have the same effect as the motion-blur correction process illustrated in the flowchart of FIG. 3.

Although the Wiener filter is used in the out-of-focus blur correction of the current frame as described above, the present technology is not limited to the Wiener filter. A filter having substantially inverse characteristics to frequency characteristics of the motion blur of the current frame serving as a correction target can be used. The same is also true in configurations as will be described later.

In addition, no motion-blur correction unit 34 may be provided in the configuration of the image processing apparatus 11 of FIG. 1 or the image processing apparatus 61 of FIG. 4.

In this case, it is possible to perform the motion-blur correction by configuring the null filling filter or a filter equivalent thereto according to the above-described Expressions (2).

### Another Modified Example of Image Processing Apparatus

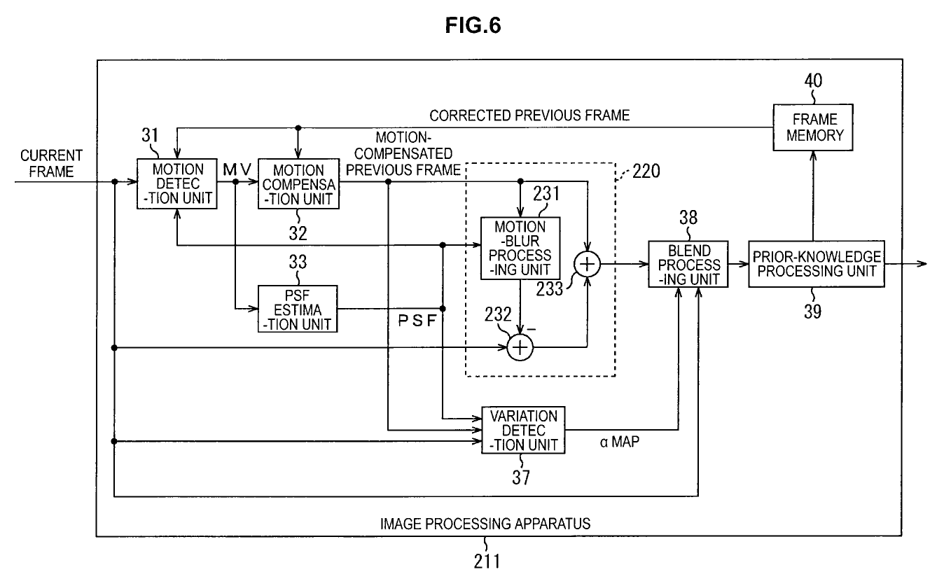

Here, the principle of motion-blur correction by the image processing apparatus without the motion-blur correction unit 34 will be described with reference to FIG. 6.

In the image processing apparatus 211 of FIG. 6, elements having the same functions as provided in the image processing apparatus 11 of FIG. 1 are denoted by the same names and the same reference numerals and description thereof is appropriately omitted.

That is, the image processing apparatus 211 of FIG. 6 is different from the image processing apparatus 11 of FIG. 1 in that a motion-blur processing unit 231 and calculation units 232 and 233 included in a processing unit 220 indicated by the dashed line in FIG. 6 are provided in place of the motion-blur correction unit 34, the zero-point-component extraction unit 35, and the synthesis unit 36.

The motion-blur processing unit 231 adds a motion blur to a motion-compensated previous frame from the motion compensation unit 32 on the basis of a PSF from the PSF estimation unit 33, and provides an addition result to the calculation unit 232.

The calculation unit 232 subtracts a motion-compensated previous frame to which the motion blur is added from the motion-blur processing unit 231 from the current frame, and provides the calculation unit 233 with a difference between the motion-compensated previous frame to which the motion blur is added and the current frame.

The calculation unit 233 adds the motion-compensated previous frame from the motion compensation unit 32 to the difference between the motion-compensated previous frame to which the motion blur is added and the current frame from the calculation unit 232, and provides an addition result to the blend processing unit 38.

The process is iterated in the configuration as described above, so that the motion blur of the current frame is gradually corrected in a direction in which the difference between the motion-compensated previous frame to which the motion blur is added and the current frame is decreased.

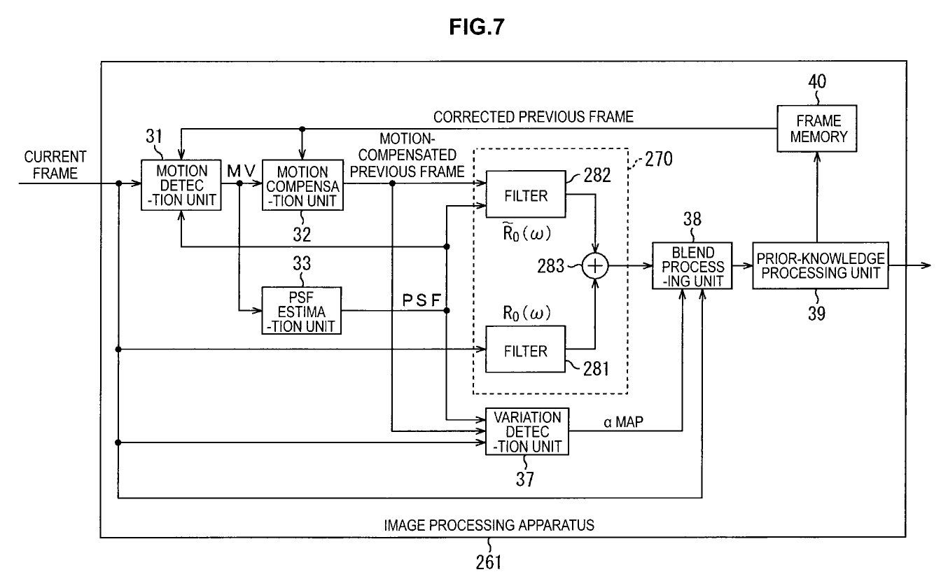

FIG. 7 is equivalent to the configuration of the image processing apparatus 211 of FIG. 6, and illustrates the configuration of the image processing apparatus corresponding to the image processing apparatus 11 of FIG. 1.

In the image processing apparatus 261 of FIG. 7, elements having the same functions as provided in the image processing apparatus 211 of FIG. 6 are denoted by the same names and the same reference numerals.

That is, the image processing apparatus 261 of FIG. 7 is different from the image processing apparatus 211 of FIG. 6 in that filters 281 and 282 and a synthesis unit 283 included in a processing unit 270 indicated by the dashed line in FIG. 7 are provided in place of the processing unit 231 and the calculation units 232 and 233 included in the processing unit 220 of FIG. 6.

The filter 281 applies a predetermined filter to a current frame, and provides an application result to the synthesis unit 283. The filter 282 applies a filter complementary to the filter 281 to a motion-compensated previous frame using a PSF from the PSF estimation unit 33, and provides an application result to the synthesis unit 283. The synthesis unit 283 synthesizes a current frame from the filter 281 with the motion-compensated previous frame from the filter 282.

Here, transfer functions of the filters 281 and 282 will be described. A transfer function R₀(ω) of the filter 281 and a transfer function \tilde{R}₀(ω) of the filter 282 are expressed by the following Expressions (4).

R₀(ω)=1

\tilde{R}₀(ω)=1−H(ω) (4)

According to Expressions (4), the filter 281 does not perform any process for the current frame. In addition, the filters 281 and 282 of the image processing apparatus 261 of FIG. 7 correspond to the motion-blur correction unit 34 and the zero-point component extraction unit 35 of the image processing apparatus 11 of FIG. 1 in terms of the configuration. Accordingly, even when the motion-blur correction unit 34 is not provided in the configuration of the image processing apparatus 11 of FIG. 1, the motion blur of the current frame is corrected by adjusting the transfer function of the zero-point component extraction unit 35.

### 3. Addition of Noise Reduction Function

Hereinafter, the addition of the noise reduction function to the image processing apparatus to which the present technology is applied will be described.

### Functional Configuration Example of Image Processing Apparatus of Related Art that Performs Noise Reduction Process

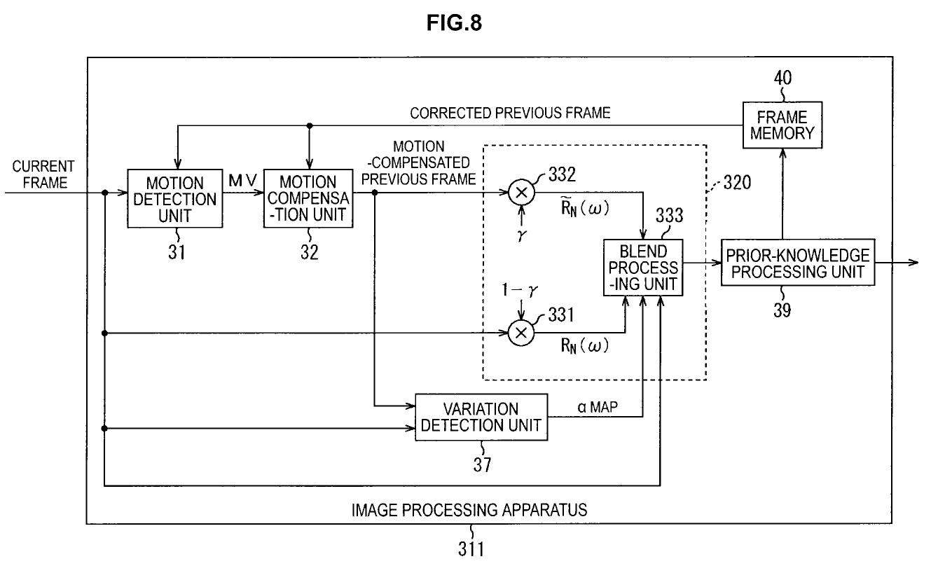

FIG. 8 is a block diagram illustrating the functional configuration example of the image processing apparatus of the related art that performs the noise reduction process.

In the image processing apparatus 311 of FIG. 8, elements having the same functions as provided in the image processing apparatus 11 of FIG. 1 are denoted by the same names and the same reference numerals.

That is, the image processing apparatus 311 of FIG. 8 is different from the image processing apparatus 11 of FIG. 1 in that the PSF estimation unit 33 is deleted and calculation units 331 and 332 and a blend processing unit 333 included in a processing unit 320 indicated by the dashed line in FIG. 8 are provided in place of the motion-blur correction unit 34, the zero-point component extraction unit 35, the synthesis unit 36, and the blend processing unit 38.

The calculation unit 331 performs weighting of frame addition to the current frame, and provides a weighting result to the blend processing unit 333. The calculation unit 332 performs weighting of frame addition to the motion-compensated previous frame, and provides a weighting result to the blend processing unit 333. The blend processing unit 333 adds the current frame from the calculation unit 331 to the motion-compensated previous frame from the calculation unit 332 according to a predetermined addition weight value, and performs a blend process for an addition result and the current frame on the basis of an α map from the variation detection unit 37. The blend processing unit 333 provides a noise-reduced frame obtained as a result to the prior-knowledge processing unit 39.

Here, when transfer functions of the calculation units 331 and 332 are R_{N}(ω) and \tilde{R}_{N}(ω), the following Expressions (5) are expressed.

R_{N}(ω)=1−γ

\tilde{R}_{N}(ω)=γ (5)

Here, γ is a weighting coefficient of frame addition. In addition, a noise-reduced frame NR output from the blend processing unit 333 is expressed by the following Expression (6).

NR=(1−αγ)·Cur+αγ·MC (6)

A specific noise reduction method is disclosed, for example, in Japanese Patent No. 4321626.

It is possible to add a configuration for implementing the above-described noise reduction to the image processing apparatus to which the present technology is applied. Specifically, the configuration for implementing the noise reduction can be added to the configuration of the image processing apparatus corresponding to the image processing apparatus 11 of FIG. 1.

### Another Functional Configuration Example of Image Processing Apparatus to which Present Technology is Applied

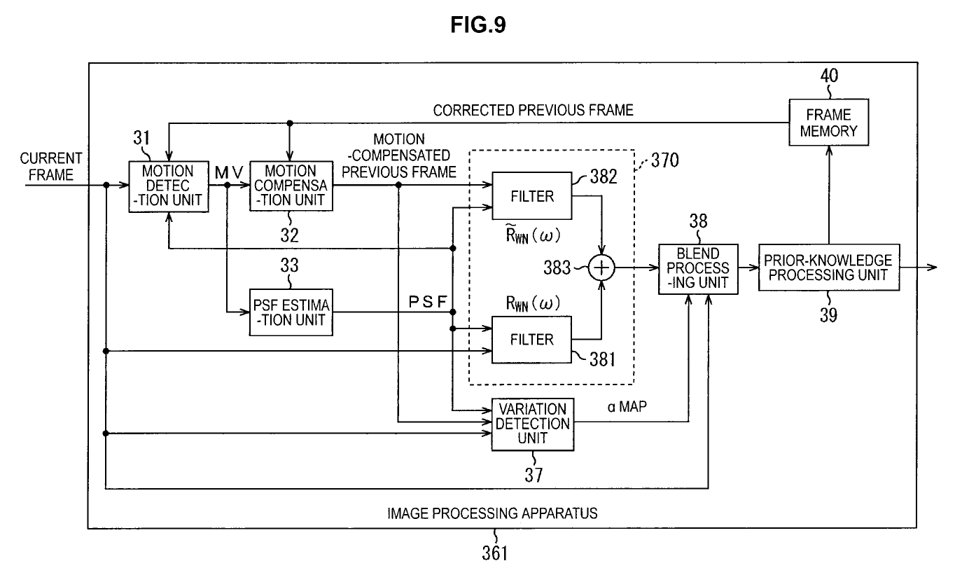

FIG. 9 illustrates another functional configuration example of the image processing apparatus to which the present technology is applied.

In the image processing apparatus 361 of FIG. 9, elements having the same functions as provided in the image processing apparatus 11 of FIG. 1 are denoted by the same names and the same reference numerals.

That is, the image processing apparatus 361 of FIG. 9 is different from the image processing apparatus 11 of FIG. 1 in that filters 381 and 382 and a synthesis unit 383 included in a processing unit 370 indicated by the dashed line in FIG. 9 are provided in place of the motion-blur correction unit 34, the zero-point component extraction unit 35, and the synthesis unit 36.

The filter 381 applies a predetermined filter to a current frame using a PSF from the PSF estimation unit 33, and provides an application result to the synthesis unit 383. The filter 382 applies a filter complementary to the filter 381 to a motion-compensated previous frame using the PSF from the PSF estimation unit 33, and provides an application result to the synthesis unit 383. The synthesis unit 383 synthesizes the current frame from the filter 381 with the motion-compensated previous frame from the filter 382.

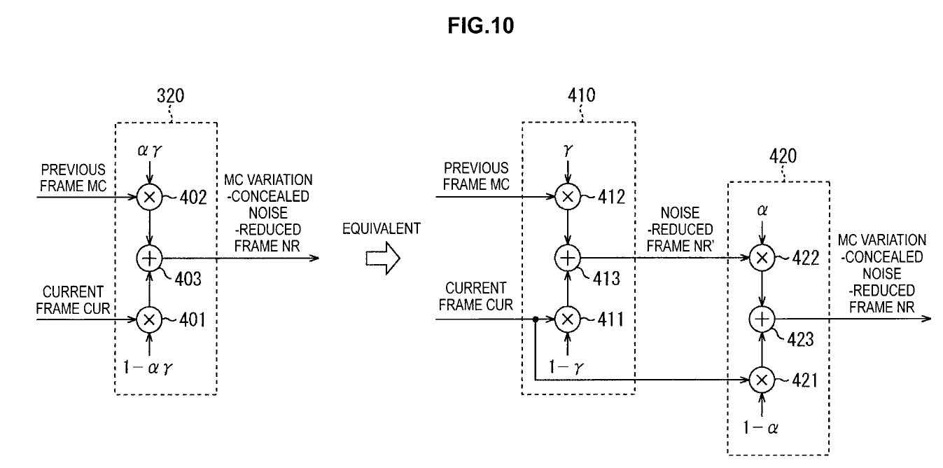

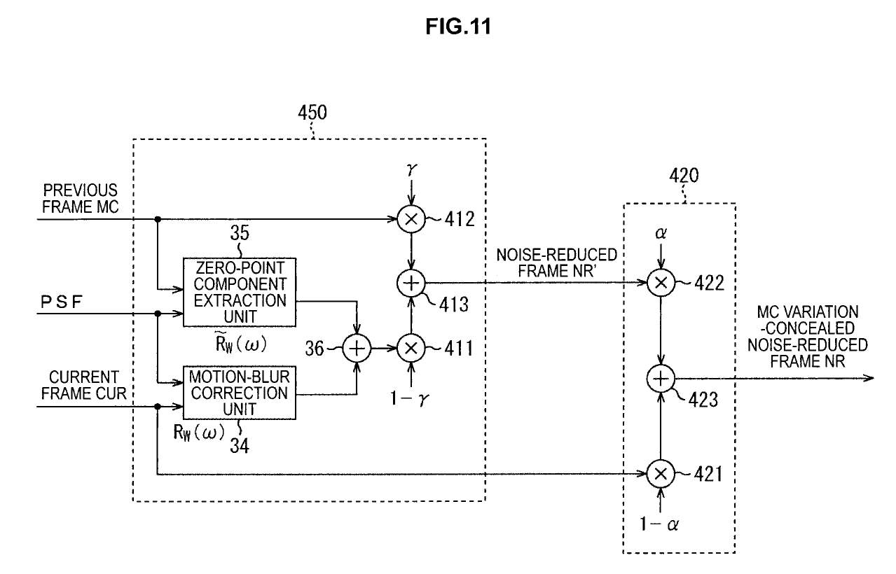

Here, the derivation of transfer functions R_{WN}(ω) and \tilde{R}_{WN}(ω) of the filters 381 and 382 will be described with reference to FIGS. 10 and 11.

The left side of FIG. 10 illustrates a configuration equivalent to the processing unit 320 of FIG. 8 including the calculation units 331 and 332 and the blend processing unit 333.

Originally, noise reduction can be implemented according to one-stage a blending by the processing unit 320 illustrated in FIG. 10. Although this is an operation of simultaneously performing frame addition of the current frame and the previous frame and concealment of MC variation, it is equivalent in principle to a configuration in which the frame addition of the current frame and the previous frame and the concealment of MC variation are independently performed.

That is, the processing unit 320 illustrated on the left side of FIG. 10 can be replaced with a processing unit 410 including calculation units 411 to 413 and a processing unit 420 including calculation units 421 and 423 illustrated on the right side of FIG. 10. The processing unit 410 performs the frame addition of the current frame and the previous frame and the processing unit 420 conceals the MC variation.

Here, a configuration in which the above-described configuration for implementing the motion-blur correction function is added to the processing unit 410 of FIG. 10 is illustrated in FIG. 11.

In a processing unit 450 of FIG. 11, the motion-blur correction unit 34, the zero-point component extraction unit 35, and the synthesis unit 36 of the image processing apparatus 11 of FIG. 1 are added to the processing unit 410 of FIG. 10, and frame addition of the zero-point-compensated current frame from the synthesis unit 36 and the motion-compensated previous frame is performed.

The processing unit 450 of FIG. 11 is equivalent to the processing unit 370 of FIG. 9, and the processing unit 420 of FIG. 11 is equivalent to the blend processing unit 38 of FIG. 9.

Here, a noise-reduced frame NR′ output from the processing unit 450 of FIG. 10 is expressed by the following Expression (7).

$$\begin{matrix}{NR}^{′} = ( 1 - γ ) \cdot ( {R}_{W} ( ω ) \cdot Cur + {\tilde{R}}_{W} ( ω ) \cdot MC ) + γ \cdot MC \\ = ( 1 - γ ) \cdot {R}_{W} ( ω ) \cdot Cur + \{ ( 1 - γ ) \cdot {\tilde{R}}_{W} ( ω ) + γ \} MC\end{matrix} \qquad ( 7 )$$

As shown in Expression (7), the noise-reduced frame NR′ includes a term related to the current frame Cur and a term related to the previous frame MC. Because the processing unit 450 of FIG. 10 is equivalent to the processing unit 370 of FIG. 9 as described above, the transfer functions R_{WN}(ω) and \tilde{R}_{WN}(ω) of the filters 381 and 382 of FIG. 9 are expressed by the following Expressions (8).

R_{WN}(ω)=(1−γ)R_{W}(ω)

\tilde{R}_{WN}(ω)=(1−γ)\tilde{R}_{W}(ω)+γ (8)

It is possible to make a configuration corresponding to the image processing apparatus 11 of FIG. 1 even when the configuration for performing the noise reduction process is added to the image processing apparatus to which the present technology is applied as described above. That is, in the image processing apparatus 11 of FIG. 1, it is possible to add the noise reduction function by adjusting the transfer functions of the motion-blur correction unit 34 and the zero-point component extraction unit 35.

[Motion-Blur Correction Process]

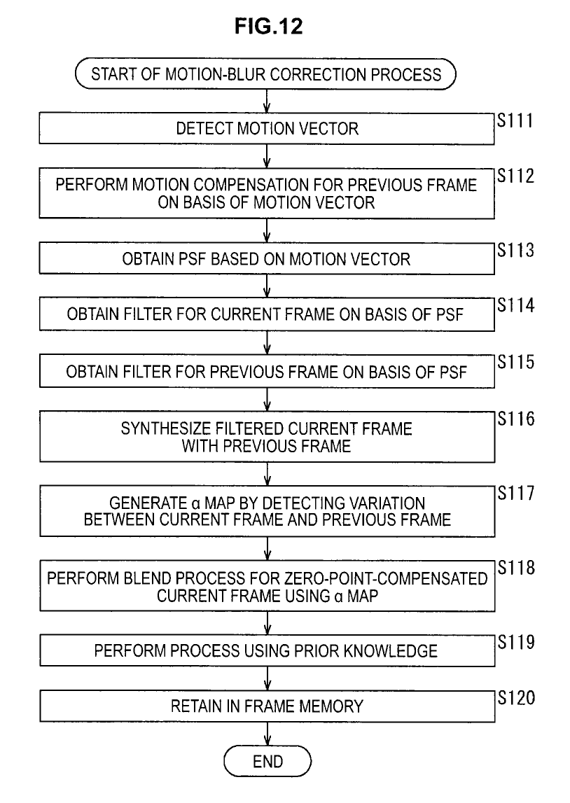

Here, the motion-blur correction process of the image processing apparatus 361 of FIG. 9 will be described with reference to the flowchart of FIG. 12.

Because the process of steps S111 to S113 and S117 to S120 of the flowchart of FIG. 12 is the same as the process of steps S11 to S13 and S17 to S20 of the flowchart of FIG. 3, description thereof is omitted.

That is, in step S114, the filter 381 obtains a filter for a current frame on the basis of a PSF from the PSF estimation unit 33, and applies the filter to the current frame. The filter 381 provides the filtered current frame to the synthesis unit 383.

In step S115, the filter 382 obtains a filter for a motion-compensated previous frame on the basis of the PSF from the PSF estimation unit 33, and applies the filter to the previous frame. The filter 382 provides the filtered previous frame to the synthesis unit 383.

In step S116, the synthesis unit 383 adds the filtered current frame from the filter 381 to the filtered previous frame from the filter 382. Thereby, a motion blur is corrected, a zero point serving as the cause of ringing is compensated for, and a noise-reduced current frame is obtained.

The above-described process can have the same effect as the motion-blur correction process, thereby reducing noise. Although deconvolution has a characteristic of amplifying noise, it is possible to suppress the amplified noise according to the present technology.

### 4. Addition of Super-Resolution Function

Hereinafter, the addition of a super-resolution function to the image processing apparatus to which the present technology is applied will be described.

The super-resolution function refers to a function of outputting an image whose number of pixels is greater than that of an input image, that is, an image having higher resolution than the input image, while restoring a high-frequency signal component from an alias component included in the input image.

### Functional Configuration Example of Image Processing Apparatus of Related Art that Performs Super-Resolution Process

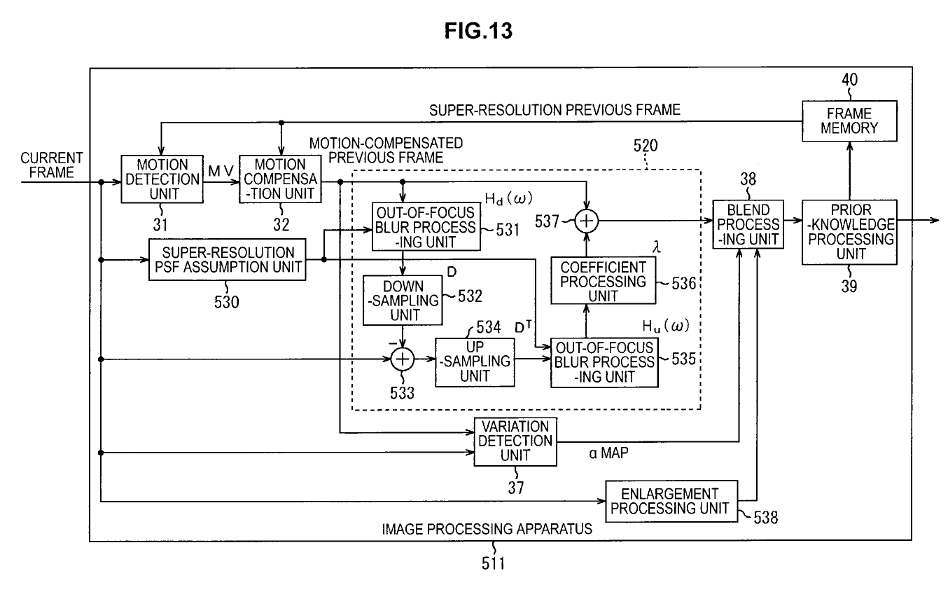

FIG. 13 is a block diagram illustrating the functional configuration example of the image processing apparatus of the related art that performs the super-resolution process.

In the image processing apparatus 511 of FIG. 13, elements having the same functions as provided in the image processing apparatus 11 of FIG. 1 are denoted by the same names and the same reference numerals.

That is, the image processing apparatus 511 of FIG. 13 is different from the image processing apparatus 11 of FIG. 1 in that a super-resolution PSF assumption unit 530 is provided in place of the PSF estimation unit 33 and an out-of-focus blur processing unit 531, a down-sampling unit 532, a calculation unit 533, an up-sampling unit 534, an out-of-focus blur processing unit 535, a coefficient processing unit 536, a calculation unit 537, and an enlargement processing unit 538 included in a processing unit 520 indicated by the dashed line in FIG. 13 are provided in place of the motion-blur correction unit 34, the zero-point component extraction unit 35, and the synthesis unit 36.

A frame having higher resolution than an input current frame obtained by a super-resolution process is retained in the frame memory 40 of FIG. 13, and provided to the motion detection unit 31 and the motion compensation unit 32 as a previous frame subjected to the super-resolution process (hereinafter referred to as a super-resolution previous frame).

The super-resolution PSF assumption unit 530 assumes an out-of-focus blur model when there is the effect of low resolution on the basis of the current frame, and provides the assumed model to the out-of-focus blur processing units 531 and 535 as the super-resolution PSF. Specifically, for example, the super-resolution PSF assumption unit 530 assumes the out-of-focus blur model by assuming the effect of a single-pixel aperture in a large image sensor.

The out-of-focus blur processing unit 531 performs an out-of-focus blur process by applying a given out-of-focus blur model in a transfer function H_{d}(ω) for a motion-compensated super-resolution previous frame (hereinafter simply referred to as a motion-compensated previous frame) on the basis of a super-resolution PSF from the super-resolution PSF assumption unit 530, and provides a processing result to the down-sampling unit 532.

The down-sampling unit 532 down-samples the motion-compensated previous frame for which the out-of-focus blur process is performed from the out-of-focus blur processing unit 531, generates an image having the same resolution as the input current frame, and provides the generated image to the calculation unit 533.

The calculation unit 533 obtains a difference (difference image) between the current frame and the down-sampled image from the down-sampling unit 532 by subtracting the down-sampled image from the down-sampling unit 532 from the current frame, and provides the obtained difference (difference image) to the up-sampling unit 534. The difference image is an error between the current frame subjected to the super-resolution process and the input current frame. This error is fed back to the motion-compensated super-resolution previous frame via the subsequent-stage up-sampling unit 534 to the coefficient processing unit 536.

The up-sampling unit 534 up-samples the difference image from the calculation unit 533, generates an image having the same resolution as the super-resolution previous frame, and provides the generated image to the out-of-focus blur processing unit 535.

The out-of-focus blur processing unit 535 performs the out-of-focus blur process by applying a given out-of-focus blur model in the transfer function Hᵤ(ω) to the up-sampled difference image from the up-sampling unit 534 on the basis of the super-resolution PSF from the super-resolution PSF assumption unit 530, and provides a processing result to the coefficient processing unit 536.

The coefficient processing unit 536 applies a coefficient λ by which the strength of a feedback is determined to the difference image subjected to the out-of-focus blur process from the out-of-focus blur processing unit 535, and provides an application result to the calculation unit 537.

The calculation unit 537 adds the motion-compensated previous frame from the motion compensation unit 32 to the difference image from the coefficient processing unit 536, and provides an obtained super-resolution image (a current frame subjected to a super-resolution process) to the blend processing unit 38.

The enlargement processing unit 538 enlarges the input current frame to an image having the same resolution as the super-resolution previous frame, and provides the enlarged frame to the blend processing unit 38.

That is, the blend processing unit 38 is configured so that the current frame enlarged by the enlargement processing unit 538 is output, for example, for an area in which MC has failed.

A specific super-resolution method is described in detail, for example, in Japanese Patent No. 4646146.

Here, a configuration included in the processing unit 520 of FIG. 13 can be replaced with a configuration including two filters and a synthesis unit, for example, as included in the processing unit 370 of FIG. 9.

At this time, if the transfer functions of the filters for current and previous frames are R_{S}(ω) and \tilde{R}_{S}(ω), respectively, the following Expressions (9) are expressed.

R_{S}(ω)=λHᵤ(ω)·D^{T}

\tilde{R}_{S}(ω)=1−λHᵤ(ω)·D^{T}·D·H_{d}(ω) (9)

In Expressions (9), D denotes down-sampling by the down-sampling unit 532, and D^{T} denotes up-sampling by the up-sampling unit 534.

In the configuration of FIG. 13, a complex conjugate of an out-of-focus blur model H_{d}(ω) of a reduction side (horizontal/vertical inversion in an impulse response) is used in an out-of-focus blur model Hᵤ(ω) of a super-resolution enlargement side. There is a problem in that a high-frequency feedback gain is insufficient and a time is long until a super-resolution image can be obtained (until convergence is reached) because there are two out-of-focus blur models H_{d}(ω) and Hᵤ(ω) in a configuration in which a difference image (error) between a current frame and a previous frame is fed back in FIG. 13.

In the present technology, an inverse filter having inverse characteristics to the out-of-focus blur model H_{d}(ω) is used as feedback characteristics Hᵤ(ω).

If H_{d}(ω)=H(ω) and Hᵤ(ω)=R_{W}(ω) in the above-described Expressions (9), the transfer functions R_{S}(ω) and \tilde{R}_{S}(ω) are the same as in Expressions (1) except for D and D^{T}.

That is, in the image processing apparatus 11 of FIG. 1, it is possible to add a configuration for performing a super-resolution process by adjusting the transfer functions of the motion-blur correction unit 34 and the zero-point component extraction unit 35.

### Still Another Functional Configuration Example of Image Processing Apparatus to which Present Technology is Applied

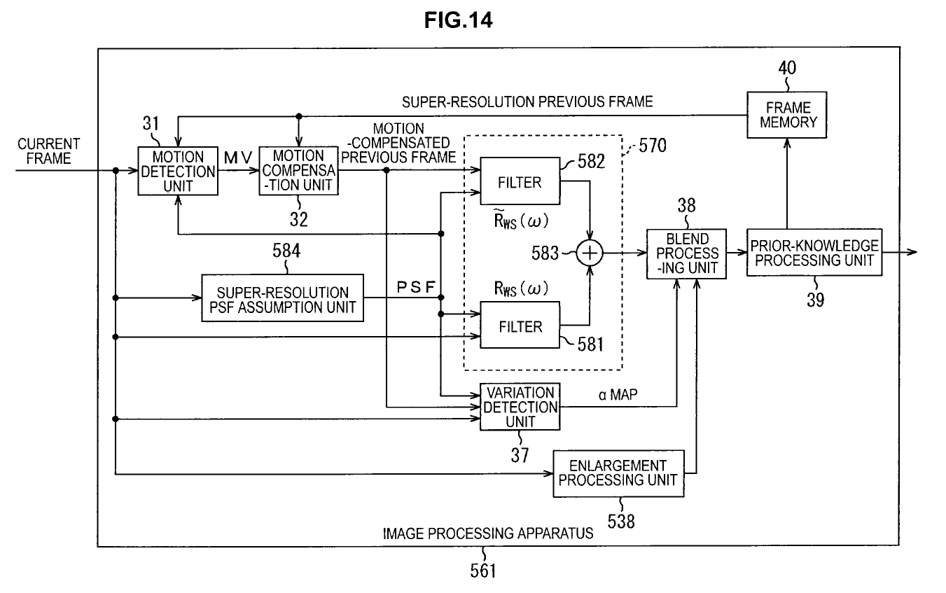

FIG. 14 illustrates the functional configuration example of the image processing apparatus of the present technology for performing a super-resolution process.

In the image processing apparatus 561 of FIG. 14, elements having the same functions as provided in the image processing apparatus 11 of FIG. 1 are denoted by the same names and the same reference numerals.

That is, the image processing apparatus 561 of FIG. 14 is different from the image processing apparatus 11 of FIG. 1 in that filters 581 and 582, a synthesis unit 583, and an enlargement processing unit 538 included in a processing unit 570 indicated by the dashed line in FIG. 11 are provided in place of the motion-blur correction unit 34, the zero-point component extraction unit 35, and the synthesis unit 36. The enlargement processing unit 538 is the same as provided in the image processing apparatus 511 of FIG. 13. In addition, the super-resolution PSF assumption unit 584 has the same function as the super-resolution PSF assumption unit 530 of FIG. 13.

The filter 581 applies a predetermined filter to the current frame using the PSF (super-resolution PSF) from the super-resolution PSF assumption unit 584, and provides an application result to the synthesis unit 583. The filter 582 applies a filter complementary to the filter 581 to a motion-compensated previous frame using the PSF from the super-resolution PSF assumption unit 584, and provides an application result to the synthesis unit 583. The synthesis unit 583 synthesizes the current frame from the filter 581 with the motion-compensated previous frame from the filter 582.

The transfer functions R_{WS}(ω) and \tilde{R}_{WS}(ω) of the filters 581 and 582 are obtained by setting H_{d}(ω)=H(ω) and Hᵤ(ω)=R_{W}(ω) in the transfer functions R_{S}(ω) and \tilde{R}_{S}(ω) shown in the above-described Expressions (9).

In addition, because a super-resolution process by the image processing apparatus 561 of FIG. 14 described with reference to the flowchart of FIG. 12 is basically the same as the motion-blur correction process by the image processing apparatus 361 of FIG. 9, description thereof is omitted.

Because an inverse filter having inverse characteristics to the out-of-focus blur model H_{d}(ω) is used as the feedback characteristics Hᵤ(ω) in the image processing apparatus that performs a super-resolution process according to the above-described configuration, it is possible to increase a high-frequency feedback gain and shorten a convergence time, thereby increasing a processing speed of the super-resolution process.

A configuration in which noise reduction described with reference to FIG. 8 is implemented can also be added in the image processing apparatus that performs the above-described super-resolution process. Specifically, the configuration in which noise reduction is implemented can be added to the configuration of the image processing apparatus corresponding to the image processing apparatus 561 of FIG. 14.

### Functional Configuration Example of Image Processing Apparatus that Simultaneously Performs Noise Reduction Process and Super-Resolution Process

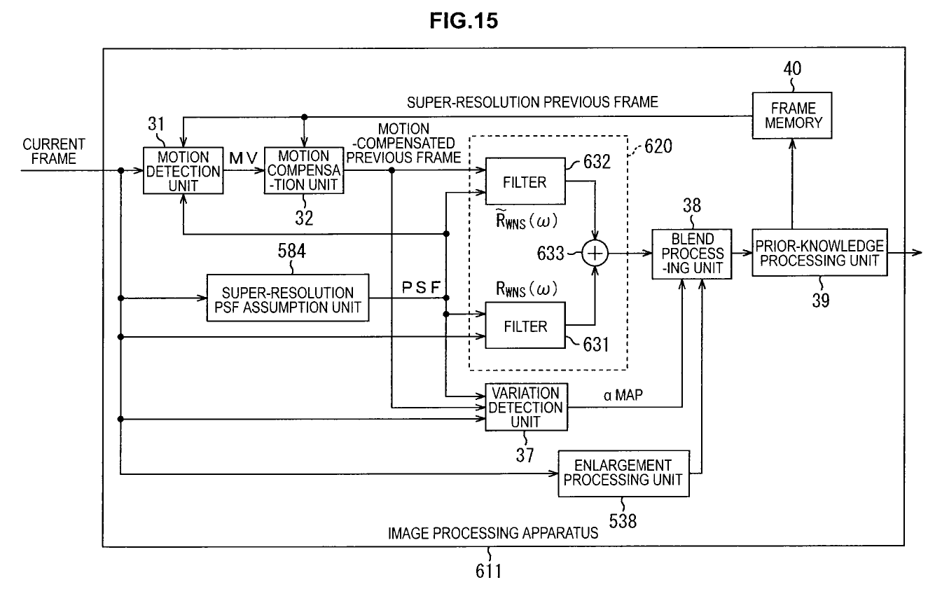

FIG. 15 illustrates a functional configuration example of the image processing apparatus that simultaneously performs the noise reduction process and the super-resolution process.

In the image processing apparatus 611 of FIG. 15, elements having the same functions as provided in the image processing apparatus 561 of FIG. 14 are denoted by the same names and the same reference numerals.

That is, the image processing apparatus 611 of FIG. 15 is different from the image processing apparatus 561 of FIG. 14 in that filters 631 and 632 and a synthesis unit 633 included in a processing unit 620 indicated by the dashed line in FIG. 15 are provided in place of the filters 581 and 582 and the synthesis unit 583 included in the processing unit 570 of FIG. 14.

The filter 631 applies a predetermined filter to a current frame using a PSF from the super-resolution PSF assumption unit 584, and provides an application result to the synthesis unit 633. The filter 632 applies a filter complementary to the filter 581 to a motion-compensated previous frame using the PSF from the super-resolution PSF assumption unit 584, and provides an application result to the synthesis unit 633. The synthesis unit 633 synthesizes the current frame from the filter 631 with the motion-compensated previous frame from the filter 632.

Here, the derivation of transfer functions R_{WNS}(ω) and \tilde{R}_{WNS}(ω) of the filters 631 and 632 will be described.

As described above, a noise reduction configuration is expressed by the processing units 410 and 420 illustrated in FIG. 10.

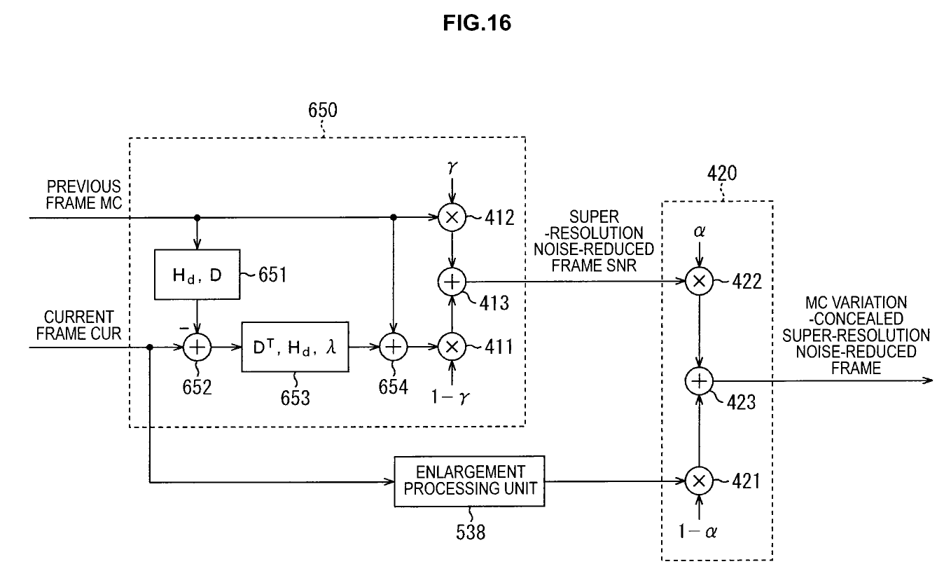

Here, a configuration in which a configuration for implementing a super-resolution function is added to the processing unit 410 of FIG. 10 is illustrated in FIG. 16.

In a processing unit 650 of FIG. 16, a filter 651, a calculation unit 652, a filter 653, and a calculation unit 654 are added to the processing unit 410 of FIG. 10, and frame addition of the current frame and the previous frame subjected to the super-resolution process is performed. In FIG. 16, the filter 651 corresponds to the out-of-focus blur processing unit 531 and the down-sampling unit 532 of FIG. 13, the calculation unit 652 corresponds to the calculation unit 533 of FIG. 13, the filter 653 corresponds to the up-sampling unit 534, the out-of-focus blur processing unit 535, and the coefficient processing unit 536 of FIG. 13, and the calculation unit 654 corresponds to the calculation unit 537 of FIG. 13.

The processing unit 650 of FIG. 16 is equivalent to the processing unit 620 of FIG. 15.

Here, a super-resolution noise-reduced frame SNR output from the processing unit 650 of FIG. 16 is expressed by the following Expression (10).

$$\begin{matrix}SNR = ( 1 - γ ) \cdot \{ λ {H}_{u} ( ω ) {D}^{T} ( Cur - {DH}_{d} ( ω ) \cdot MC ) + MC \} + γ \cdot MC \\ = ( 1 - γ ) \cdot λ {H}_{u} ( ω ) {D}^{T} \cdot Cur + \\ \{ ( 1 - γ ) \cdot ( 1 - γ {H}_{u} ( ω ) {D}^{T} \cdot D \cdot {H}_{d} ( ω ) ) + γ \} MC\end{matrix} \qquad ( 10 )$$

As shown in Expression (10), the super-resolution noise-reduced frame SNR includes a term related to the current frame Cur and a term related to the previous frame MC. Because the processing unit 650 of FIG. 1 is equivalent to the processing unit 620 of FIG. 15 as described above, the derivation of transfer functions R_{WNS}(ω) and \tilde{R}_{WNS}(ω) of the filters 631 and 632 of FIG. 15 are given as shown in the following Expressions (11).

R_{WNS}(ω)=(1−γ)·λHᵤ(ω)·D^{T}

\tilde{R}_{WNS}(ω)=(1−γ)·(1−λHᵤ(ω)·D^{T}·D·H_{d}(ω))+γ (11)

Even when a configuration in which the noise reduction process is performed is added to the image processing apparatus that performs the super-resolution process as described above, it is possible to make a configuration corresponding to the image processing apparatus 561 of FIG. 14 and simultaneously implement super-resolution and noise reduction. In addition, as shown in Expressions (11), the transfer functions R_{WNS}(ω) and \tilde{R}_{WNS}(ω) of the filters 631 and 632 are equivalent to transfer functions obtained by applying noise reduction to a super-resolution result. The effect of each of the super-resolution and the noise reduction can be obtained without loss.

### 5. Example of PSF Estimation Method

The PSF estimation method used in the present technology is not limited to the method based on the above-described motion vector.

As a method of estimating a motion blur from an image, various methods such as a method using cepstrum conversion and a method using an out-of-focus blur of a boundary part of an object are well-known. These may be applied to the present technology.

In addition, the PSF used in the present technology is not limited to a model of a linear motion blur. In most PSFs, there is the zero point in frequency characteristics. According to the above-described technique, the null filling filter can be configured. For example, a PSF for modeling a hand-motion blur of a free trajectory or an out-of-focus blur may be used in the present technology. That is, according to the embodiments of the present technology, it is possible to correct the hand-motion blur or the out-of-focus blur with a smaller circuit scale and a smaller calculation amount while suppressing an artifact such as ringing or a ghost.

If the PSF of the out-of-focus blur is modeled as a circle of confusion, its frequency characteristics are expressed by a rotational symmetrical Bessel function and have a periodic zero point as in frequency characteristics in which the linear motion blur is modeled. In this case, it is possible to estimate a radius of the circle of confusion from a spectrum of an image. When auto focus (AF) functions in a camera for inputting a captured image, the null filling filter between frames effectively operates because a size of the circle of confusion varies with each frame and a position of the zero point also varies.

In addition, it is possible to estimate the PSF according to a method other than a method of estimating the PSF from an image. For example, it is possible to estimate the PSF by the hand-motion blur by attaching a gyro sensor to the camera and measuring the rotation of the camera by the gyro sensor. In addition, when the camera is installed on an automatic camera platform (pan/tilt) capable of mechanically varying a direction of an optical axis or when the camera is provided with a mechanism that mechanically operates an image sensor, it is possible to estimate the PSF by observing an operation of the automatic camera platform or the image sensor.

Incidentally, although the PSF is obtained by (motion vector (MV))×(Exposure Time)÷(Frame Cycle) in the above-described configuration and process, the PSF is correctly obtained only when the object has constant velocity motion on a screen.

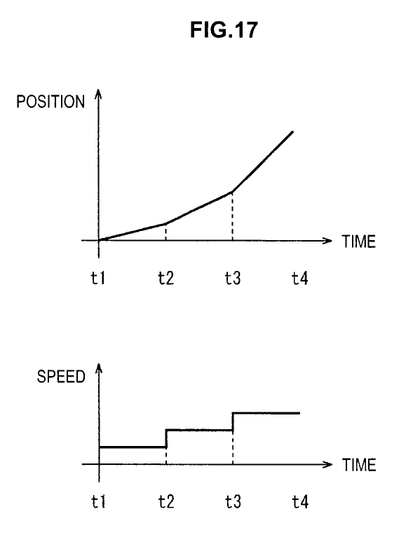

Here, when an object as a moving body on the screen is determined to have linear motion in constant velocity within a frame of each of times t1 to t2, times t2 to t3, and times t3 to t4 and to have uniformly accelerated motion in the frame of each of the times t1 to t2, the times t2 to t3, and the times t3 to t4 as illustrated in FIG. 17, it is possible to obtain a motion blur for a frame of interest on the basis of the frame of interest and two frames temporally previous and subsequent to the frame of interest, that is, three adjacent frames.

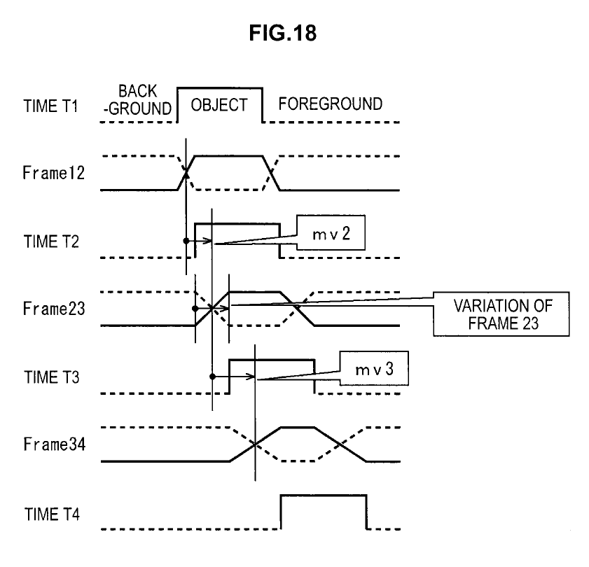

FIG. 18 is a diagram illustrating a position of a moving object illustrated in FIG. 17 at each time of the times t1 to t4 and a state of a motion blur of the object in each frame.

In FIG. 18, when a frame of interest is Frame 23 of the times t2 to t3, a motion blur of Frame 23 (a part in which the object and a background are included together as a boundary part between the object and the background) is given as an arithmetic average between a motion vector (mv2) obtained from Frame 12 previous to the frame of interest and Frame 23 and a motion vector (mv3) obtained from Frame 23 and Frame 34 subsequent to the frame of interest.

Thereby, even when the object has uniformly accelerated motion, it is possible to correctly obtain the PSF by obtaining two motion vectors based on three adjacent frames.

Incidentally, when the object, which is a moving object in the static background, moves, the background is gradually thinned without a motion blur, and the motion-blurred object is gradually thickened in the boundary part between the object and the background at a moving direction side (forward) of the object. In addition, in the boundary part between the object and the background at a reflection side (backward) of the object, the background is gradually thickened without a motion blur, and the motion-blurred object is gradually thinned. As described above, it is necessary to remove the background of the boundary part so as to perform motion-blur correction only for the motion-blurred object.

### 6. Configuration of Image Processing Apparatus that Performs Motion-Blur Correction Only for Motion-Blurred Object

Hereinafter, the configuration of the image processing apparatus that performs motion-blur correction only for a motion-blurred object will be described.

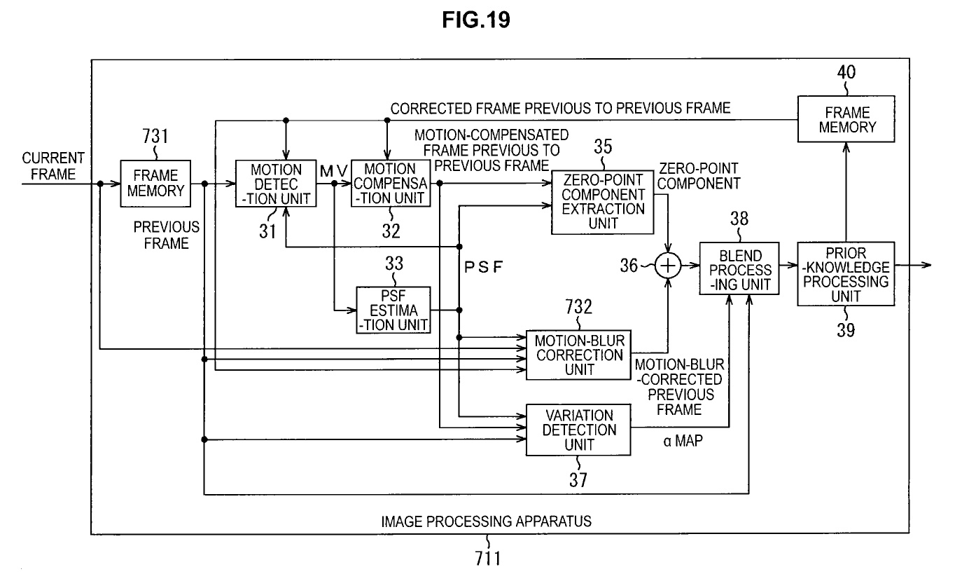

FIG. 19 illustrates the configuration of the image processing apparatus that performs the motion-blur correction only for the motion-blurred object by removing the background of the boundary part.

In the image processing apparatus 711 of FIG. 19, elements having the same functions as provided in the image processing apparatus 11 of FIG. 1 are denoted by the same names and the same reference numerals.

That is, the image processing apparatus 711 of FIG. 19 is different from the image processing apparatus 11 of FIG. 1 in that a frame memory 731 is newly provided and a motion-blur correction unit 732 is provided in place of the motion-blur correction unit 34.

The frame memory 731 retains the current frame input to the image processing apparatus 711, delays the current frame by the time of one frame, and provides the delayed frame to the motion detection unit 31, the variation detection unit 37, the blend processing unit 38, and the motion-blur correction unit 732.

The motion-blur correction unit 732 removes a background part of a previous frame on the basis of a previous frame from the frame memory 731 and a frame (hereinafter referred to as the frame previous to the previous frame), which is one frame earlier than the previous frame, retained in the frame memory 40. The motion-blur correction unit 732 configures a Wiener filter on the basis of a PSF from the PSF estimation unit 33 and applies the Wiener filter to an object part of the previous frame from which the background part is removed, thereby obtaining the motion-blur-corrected previous frame in the object part and providing the motion-blur-corrected previous frame to the synthesis unit 36.

In the image processing apparatus 711 of FIG. 19, the previous frame output from the frame memory 731 is processed as a frame of interest.

[Configuration of Motion-Blur Correction Unit]

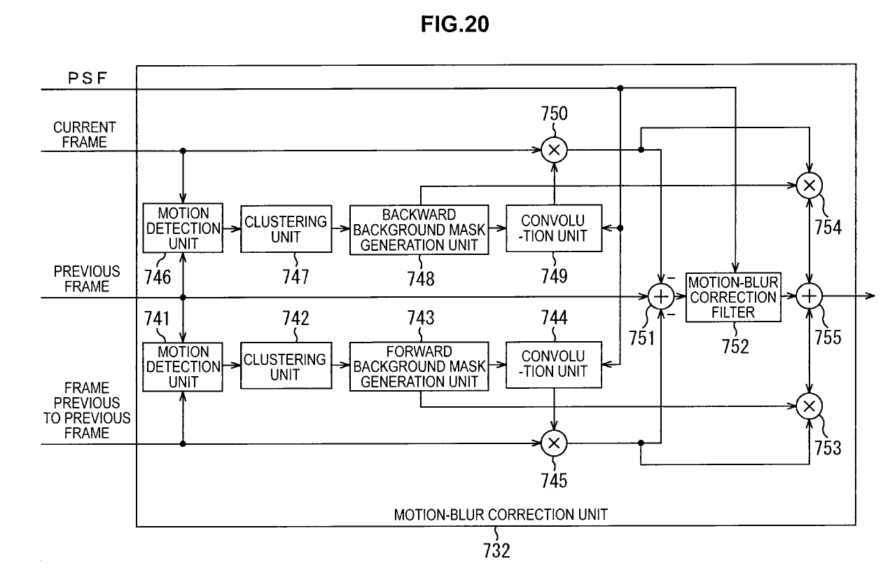

Next, a detailed configuration example of the motion-blur correction unit 732 of the image processing apparatus 711 of FIG. 19 will be described with reference to FIG. 20.

The motion-blur correction unit 732 includes a motion detection unit 741, a clustering unit 742, a forward background mask generation unit 743, a convolution unit 744, a calculation unit 745, a motion detection unit 746, a clustering unit 747, a backward background mask generation unit 748, a convolution unit 749, calculation units 750 and 751, a motion-blur correction filter 752, and calculation units 753, 754, and 755.

The motion detection unit 741 performs ME (motion detection) for a frame previous to a previous frame and the previous frame, obtains motion vectors, and provides the obtained motion vectors to the clustering unit 742.

The clustering unit 742 clusters the motion vectors from the motion detection unit 741, classifies the motion vectors into a vector (0 vector) of a static background part and a vector of a moving object part, and provides the classified vectors to the forward background mask generation unit 743 as a classification result.

The forward background mask generation unit 743 generates a forward background mask for masking the background including the motion-blurred object part in the front of the object in the previous frame on the basis of the classification result of the motion vectors from the clustering unit 742, and provides the forward background mask to the convolution unit 744 and the calculation unit 753.

The convolution unit 744 generates a forward background weight map for weighting a gradually thinned background part by convoluting a PSF with the forward background mask from the forward background mask generation unit 743, and provides the generated forward background weight map to the calculation unit 745.

The calculation unit 745 generates an image (forward background image) of only a gradually thinned background part by applying the forward background weight map from the convolution unit 744 to the frame previous to the previous frame, and provides the generated image to the calculation unit 751.

The motion detection unit 746 performs ME for a previous frame and a current frame, obtains motion vectors, and provides the obtained motion vectors to the clustering unit 747.

The clustering unit 747 clusters the motion vectors from the motion detection unit 746, classifies the motion vectors into a vector (0 vector) of a static background part and a vector of a moving object part, and provides the classified vectors to the backward background mask generation unit 748 as a classification result.

The backward background mask generation unit 748 generates a backward background mask for masking the background including the motion-blurred object part in the rear of the object in the previous frame on the basis of the classification result of the motion vectors from the clustering unit 747, and provides the backward background mask to the convolution unit 749 and the calculation unit 754.

The convolution unit 749 generates a backward background weight map for weighting a gradually thinned background part by convoluting a PSF with the backward background mask from the backward background mask generation unit 748, and provides the generated backward background weight map to the calculation unit 750.

The calculation unit 750 generates an image (backward background image) of only a gradually thickened background part by applying the backward background weight map from the convolution unit 749 to the current frame, and provides the generated image to the calculation unit 751.

The calculation unit 751 subtracts (removes) the background image from the previous frame on the basis of the forward background image from the calculation unit 745 and the backward background image from the calculation unit 750, thereby extracting the image of the motion-blurred object (hereinafter also simply referred to as an object part) and providing the extracted image to the motion-blur correction filter 752.

The motion-blur correction filter 752 configures a Wiener filter on the basis of a PSF and applies the Wiener filter to the object part, thereby obtaining the motion-blur-corrected object part and providing the motion-blur-corrected object part to the calculation unit 755.

The calculation unit 753 applies the forward background mask from the forward background mask generation unit 743 to the frame previous to the previous frame, and provides an application result to the calculation unit 755.

The calculation unit 754 applies the backward background mask from the backward background mask generation unit 748 to the current frame, and provides an application result to the calculation unit 755.

The calculation unit 755 generates a background image without the motion blur on the basis of the frame previous to the previous frame from the calculation unit 753 and the current frame from the calculation unit 754, synthesizes the generated background image with the motion-blur-corrected object part from the motion-blur correction filter 752, and provides a synthesis result to the synthesis unit 36 of FIG. 19.

[Motion-Blur Correction Process]

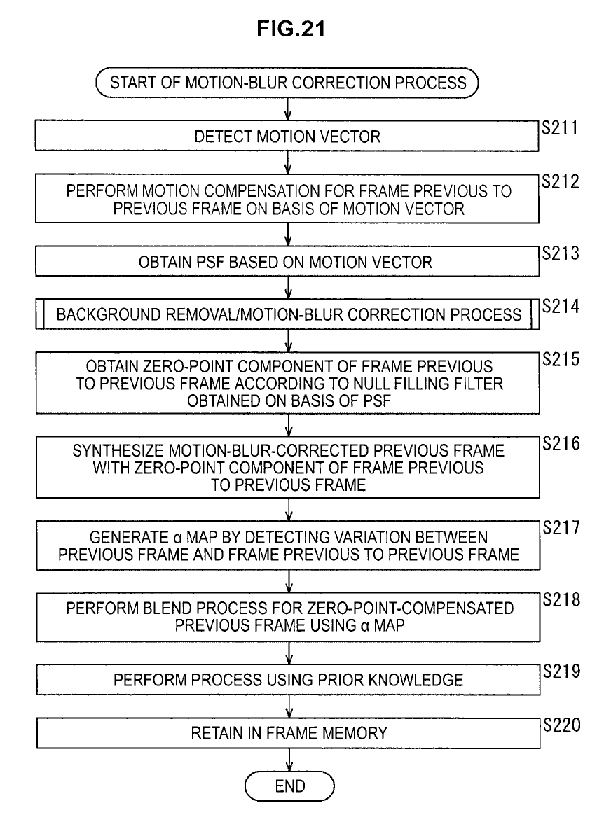

Next, the motion-blur correction process of the image processing apparatus 711 of FIG. 19 will be described with reference to the flowchart of FIG. 21.

Because the process of steps S211 to S213 and S215 to S220 of the flowchart of FIG. 21 is the same as the process of steps S11 to S13 and S15 to S20 except that the frame of interest is not the current frame but the previous frame, description thereof is omitted.

That is, in step S214, the motion-blur correction unit 732 executes a background removal/motion-blur correction process.

[Background-Removal/Motion-Blur Correction Process]

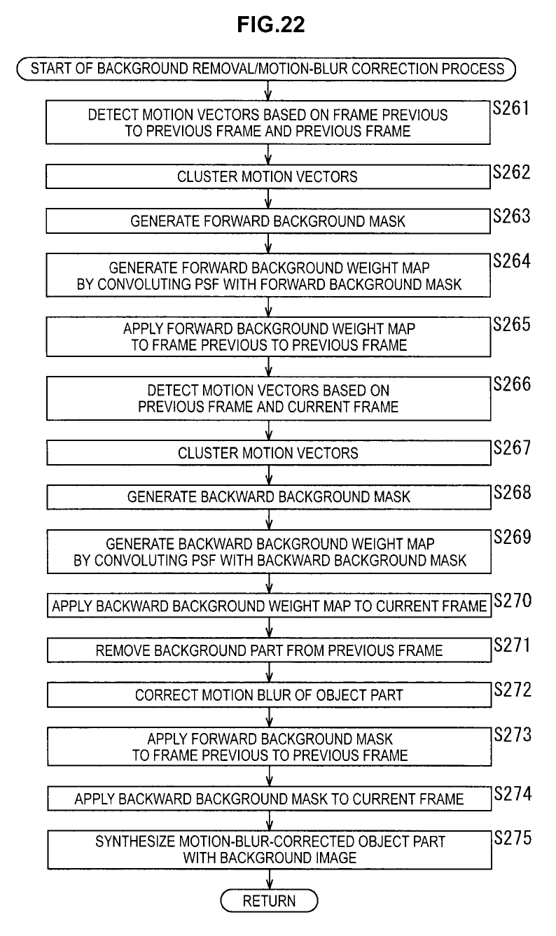

Here, the background-removal/motion-blur correction process of the motion-blur correction unit 732 will be described with reference to the flowchart of FIG. 22.

In step S261, the motion detection unit 741 detects motion vectors on the basis of a frame previous to a previous frame and the previous frame, and provides the detected motion vectors to the clustering unit 742.

In step S262, the clustering unit 742 clusters the motion vectors from the motion detection unit 741, and provides a classification result to the forward background mask generation unit 743.

In step S263, the forward background mask generation unit 743 generates a forward background mask on the basis of the classification result of the motion vectors from the clustering unit 742, and provides the generated forward background mask to the convolution unit 744 and the calculation unit 753.

In step S264, the convolution unit 744 generates a forward background weight map by convoluting a PSF with the forward background mask from the forward background mask generation unit 743, and provides the generated forward background weight map to the calculation unit 745.

In step S265, the calculation unit 745 generates a forward background image by applying the forward background weight map from the convolution unit 744 to the frame previous to the previous frame, and provides the generated image to the calculation unit 751.

In step S266, the motion detection unit 746 detects motion vectors on the basis of a previous frame and a current frame, and provides the detected motion vectors to the clustering unit 747.

In step S267, the clustering unit 747 clusters the motion vectors from the motion detection unit 746 and provides its classification result to the backward background mask generation unit 748.

In step S268, the backward background mask generation unit 748 generates a backward background mask on the basis of the classification result of the motion vectors from the clustering unit 747, and provides the backward background mask to the convolution unit 749 and the calculation unit 754.

In step S269, the convolution unit 749 generates a backward background weight map by convoluting a PSF with the backward background mask from the backward background mask generation unit 748, and provides the generated backward background weight map to the calculation unit 750.

In step S270, the calculation unit 750 generates a backward background image by applying the backward background weight map from the convolution unit 749 to the current frame, and provides the generated image to the calculation unit 751.

The process of steps S261 to S265 and the process of steps S266 to S270 may be executed in parallel.

In step S271, the calculation unit 751 removes the background part from the previous frame on the basis of the forward background image from the calculation unit 745 and the backward background image from the calculation unit 750, thereby extracting the image of the motion-blurred object (the object part) and providing the extracted image to the motion-blur correction filter 752.

In step S272, the motion-blur correction filter 752 configures a Wiener filter on the basis of a PSF and applies the Wiener filter to the object part, thereby correcting the motion blur of the object part and providing the motion-blur-corrected object part to the calculation unit 755.

In step S273, the calculation unit 753 applies the forward background mask from the forward background mask generation unit 743 to the frame previous to the previous frame, and provides an application result to the calculation unit 755.

In step S274, the calculation unit 754 applies the backward background mask from the backward background mask generation unit 748 to the current frame, and provides an application result to the calculation unit 755.

In step S275, the calculation unit 755 generates a background image without the motion blur on the basis of the frame previous to the previous frame from the calculation unit 753 and the current frame from the calculation unit 754, and synthesizes the generated background image with the motion-blur-corrected object part from the motion-blur correction filter 752. Thereafter, the process returns to step S214 of the flowchart of FIG. 21.

According to the above process, it is possible to perform motion-blur correction only for a motion-blurred object while removing a background of a boundary part even when an object, which is a moving body, moves in a static background. In this case, it is preferable that the frame memory for two frames be provided, and it is possible to correct a motion blur with a comparatively small circuit scale.

Although a current frame becomes a frame of interest and a background removal/motion-blur correction process is executed on the basis of the current frame and a previous frame if the frame memory 731 is not provided in the configuration of the image processing apparatus 711 of FIG. 19, it may be impossible to correct a motion blur of a boundary part in the rear of the object because information of a frame after a frame subsequent to the frame of interest is not obtained. However, because the boundary part in the rear of the object in the moving image is delayed by the time of one frame and replaced with a background, its influence is limited. That is, only the frame memory (frame memory 40) for one frame may be provided in the image processing apparatus 711 of FIG. 19 in terms of the moving image.

The above-described series of processes can be executed by hardware or software. When the series of processes is executed by software, a program constituting the software is installed from a program recording medium to a computer embedded in dedicated hardware or a computer such as a general-purpose personal computer capable of executing various functions by installing various programs.

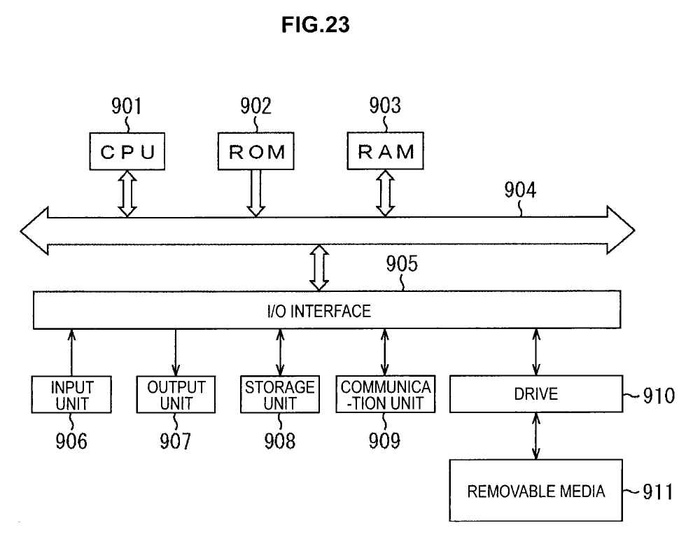

FIG. 23 is a block diagram illustrating a configuration example of hardware of a computer, which executes the above-described series of processes by a program.

In the computer, a central processing unit (CPU) 901, a read-only memory (ROM) 902, and a random access memory (RAM) 903 are connected to each other via a bus 904.

An input/output (I/O) interface 905 is further connected to the bus 904. An input unit 906 constituted by a keyboard, a mouse, a microphone, and the like, an output unit 907 constituted by a display, a speaker, and the like, a storage unit 908 constituted by a hard disk, a non-volatile memory, and the like, a communication unit 909 constituted by a network interface and the like, and a drive 910, which drives removable media 911 such as a magnetic disk, an optical disc, a magneto-optical disc, and a semiconductor memory, are connected to the I/O interface 905.

In the computer having such a configuration, the CPU 901 loads and executes, for example, a program stored in the storage unit 908 on the RAM 903 via the I/O interface 905 and the bus 904 to perform the above-described series of processes.

The program to be executed by the computer (CPU 901) is recorded on the removable media 911, which are package media including a magnetic disk (including a flexible disk), an optical disc (compact disc-read only memory (CD-ROM), digital versatile disc (DVD), and the like), a magneto-optical disc, a semiconductor memory, and the like. Alternatively, the program is provided via a wired or wireless transmission medium such as a local area network, the Internet, or digital satellite broadcasting.

The program may be installed in the storage unit 908 via the I/O interface 905 by mounting the removable media 911 on the drive 910. The program can be received via a wired or wireless transmission medium via the communication unit 909 and may be installed in the storage unit 908. The program can also be installed in advance to the ROM 902 or the storage unit 908.

The program executed by the computer may be a program in which the processes are performed in the chronological order described in this specification or a program in which the processes are performed in parallel or at appropriate timings such as when called upon.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) There is provided an image processing apparatus for correcting a motion blur or an out-of-focus blur of images continuous in time, including: an extraction unit for extracting a frequency component not included in an image of interest using a predetermined filter from a corrected image in which the motion blur or the out-of-focus blur is corrected as an image temporally previous to the image of interest aligned with the image of interest; and a synthesis unit for synthesizing the frequency component extracted by the extraction unit with the image of interest.

(2) The image processing apparatus according to (1) further includes: a correction unit for correcting the motion blur or the out-of-focus blur of the image of interest using a complementary filter, which has substantially inverse characteristics to frequency characteristics of the motion blur or the out-of-focus blur and is complementary to the filter, wherein the synthesis unit synthesizes the image of interest the motion blur or the out-of-focus blur of which is corrected by the correction unit with the frequency component.

(3) The image processing apparatus according to (1) or (2) further includes: an addition unit for adding the image of interest, which is synthesized with the frequency component by the synthesis unit, to the corrected image according to a predetermined addition weight.

(4) In the image processing apparatus according to (1) or (2), resolution of the corrected image is second resolution, which is higher than first resolution as resolution of the image of interest, and the filter and the complementary filter set the resolution of the image of interest from the first resolution to the second resolution.

(5) The image processing apparatus according to (4) further includes: an addition unit for adding the image of interest of the second resolution and the corrected image according to a predetermined addition weight.

(6) The image processing apparatus according to any one of (1) to (5) further includes: a detection unit for detecting variation in alignment with the image of interest and the corrected image; and an output unit for outputting an image obtained by adjusting a rate of synthesis of the image of interest, which is synthesized with the frequency component by the synthesis unit, with the image of interest, which is not subjected to any process, according to the variation detected by the detection unit.

(7) The image processing apparatus according to any one of (2) to (6), further includes: an estimation unit for estimating a direction and a length of the motion blur or the out-of-focus blur of the image of interest on the basis of variation of a position between the image of interest and the corrected image, wherein the correction unit corrects the motion blur or the out-of-focus blur of the image of interest using the complementary filter corresponding to the direction and the length of the motion blur or the out-of-focus blur of the image of interest estimated by the estimation unit.

(8) In the image processing apparatus according to any one of (2) to (7), the correction unit corrects the motion blur or the out-of-focus blur of an object in the image of interest by removing a background part other than the object, which is a moving body in the image of interest, on the basis of the corrected image, the image of interest, and an image temporally subsequent to the image of interest.

(9) In the image processing apparatus according to any one of (1) to (8), the frequency component not included in the image of interest is a frequency component in the vicinity of a zero point of frequency characteristics in which the motion blur or the out-of-focus blur of the image of interest is modeled.

(10) There is provided an image processing method for use in an image processing apparatus for correcting a motion blur or an out-of-focus blur of images continuous in time, wherein the image processing apparatus includes an extraction unit for extracting a frequency component not included in an image of interest using a predetermined filter from a corrected image in which the motion blur or the out-of-focus blur is corrected as an image temporally previous to the image of interest aligned with the image of interest, and a synthesis unit for synthesizing the frequency component extracted by the extraction unit with the image of interest, the image processing method including: extracting, by way of the image processing apparatus, the frequency component not included in the image of interest using the predetermined filter from the corrected image in which the motion blur or the out-of-focus blur is corrected as the image temporally previous to the image of interest aligned with the image of interest; and synthesizing, by way of the image processing apparatus, the extracted frequency component with the image of interest.

(11) There is provided a program for causing a computer to execute a process of correcting a motion blur or an out-of-focus blur of images continuous in time, including extracting a frequency component not included in an image of interest using a predetermined filter from a corrected image in which the motion blur or the out-of-focus blur is corrected as an image temporally previous to the image of interest aligned with the image of interest; and synthesizing the frequency component extracted by a process of the extracting step with the image of interest.

(12) There is provided a recording medium recording the program according to (11).

The present disclosure contains subject matter related to that disclosed in Japanese Priority Patent Application JP 2011-130652 filed in the Japan Patent Office on Jun. 10, 2011, the entire content of which is hereby incorporated by reference.

What is claimed is:

1. An image processing apparatus for correcting a motion blur or an out-of-focus blur of images continuous in time, comprising:
an extraction unit for extracting a frequency component not included in an image of interest using a predetermined filter from a corrected image in which the motion blur or the out-of-focus blur is corrected as an image temporally previous to the image of interest aligned with the image of interest; and
a synthesis unit for synthesizing the frequency component extracted by the extraction unit with the image of interest.

2. The image processing apparatus according to claim 1, further comprising:
a correction unit for correcting the motion blur or the out-of-focus blur of the image of interest using a complementary filter, which has substantially inverse characteristics to frequency characteristics of the motion blur or the out-of-focus blur and is complementary to the filter,
wherein the synthesis unit synthesizes the image of interest the motion blur or the out-of-focus blur of which is corrected by the correction unit with the frequency component.

3. The image processing apparatus according to claim 2, further comprising:
an addition unit for adding the image of interest, which is synthesized with the frequency component by the synthesis unit, to the corrected image according to a predetermined addition weight.

4. The image processing apparatus according to claim 2,
wherein resolution of the corrected image is second resolution, which is higher than first resolution as resolution of the image of interest, and
wherein the filter and the complementary filter set the resolution of the image of interest from the first resolution to the second resolution.

5. The image processing apparatus according to claim 4, further comprising:
an addition unit for adding the image of interest of the second resolution and the corrected image according to a predetermined addition weight.

6. The image processing apparatus according to claim 2, further comprising:
a detection unit for detecting variation in alignment with the image of interest and the corrected image; and
an output unit for outputting an image obtained by adjusting a rate of synthesis of the image of interest, which is synthesized with the frequency component by the synthesis unit, with the image of interest, which is not subjected to any process, according to the variation detected by the detection unit.

7. The image processing apparatus according to claim 2, further comprising:
an estimation unit for estimating a direction and a length of the motion blur or the out-of-focus blur of the image of interest on the basis of variation of a position between the image of interest and the corrected image,
wherein the correction unit corrects the motion blur or the out-of-focus blur of the image of interest using the complementary filter corresponding to the direction and the length of the motion blur or the out-of-focus blur of the image of interest estimated by the estimation unit.

8. The image processing apparatus according to claim 2, wherein the correction unit corrects the motion blur or the out-of-focus blur of an object in the image of interest by removing a background part other than the object, which is a moving body in the image of interest, on the basis of the corrected image, the image of interest, and an image temporally subsequent to the image of interest.

9. The image processing apparatus according to claim 1, wherein the frequency component not included in the image of interest is a frequency component in the vicinity of a zero point of frequency characteristics in which the motion blur or the out-of-focus blur of the image of interest is modeled.

10. An image processing method for use in an image processing apparatus for correcting a motion blur or an out-of-focus blur of images continuous in time, wherein the image processing apparatus includes an extraction unit for extracting a frequency component not included in an image of interest using a predetermined filter from a corrected image in which the motion blur or the out-of-focus blur is corrected as an image temporally previous to the image of interest aligned with the image of interest, and a synthesis unit for synthesizing the frequency component extracted by the extraction unit with the image of interest, the image processing method comprising:
extracting, by way of the image processing apparatus, the frequency component not included in the image of interest using the predetermined filter from the corrected image in which the motion blur or the out-of-focus blur is corrected as the image temporally previous to the image of interest aligned with the image of interest; and
synthesizing, by way of the image processing apparatus, the extracted frequency component with the image of interest.

11. A program for causing a computer to execute a process of correcting a motion blur or an out-of-focus blur of images continuous in time, comprising:
extracting a frequency component not included in an image of interest using a predetermined filter from a corrected image in which the motion blur or the out-of-focus blur is corrected as an image temporally previous to the image of interest aligned with the image of interest; and
synthesizing the frequency component extracted by a process of the extracting step with the image of interest.

12. A recording medium recording the program according to claim 11.
